(19) United States
(12) Patent Application Publication
(10) Pub. No.: US 2020/0151790 A1
(43) Pub. Date: May 14, 2020

(54) SYSTEM AND METHOD FOR FACILITATING REMOTE RETAIL TRANSACTIONS BETWEEN SALES ASSOCIATES AND CUSTOMERS AND PROVIDING A SECURE PAYMENT MECHANISM

(71) Applicant: Muncey, Inc., New York, NY (US)

(72) Inventor: Young Jin Oh, New York, NY (US)

(21) Appl. No.: 16/186,145

(22) Filed: Nov. 9, 2018

(51) Int. Cl. G06Q 30/06; G06Q 20/40

(52) U.S. Cl. CPC G06Q 30/0613; G06Q 20/4014; G06K 19/06037; G06Q 30/0625; G06Q 30/0609

(57) ABSTRACT

A method and apparatus are disclosed for facilitating retail transactions between a sales associate and a customer who are remote from one another and for providing a secure payment mechanism. Customers and sales associates each operate a software application on client devices that interact with a server. The software application enables a customer to find sales associates who are physically nearby and who have expertise in a product line of interest. The software application also allows a sales associate to find customers who are physically nearby and who are interested in a product line in which the sales associate has expertise. A customer and sales associate can communicate electronically and can consummate a purchase using a secure payment approval mechanism and subsequent payment mechanism provided by the software application. The sales associate can meet the customer in person to deliver the merchandise or the sales associate can arrange to have the merchandise shipped to the customer.

### TECHNICAL FIELD

A method and apparatus are disclosed for facilitating remote retail transactions between merchants and customers and providing a secure payment approval mechanism and a subsequent payment execution mechanism.

### BACKGROUND OF THE INVENTION

The prior art includes two primary types of retail mechanisms. The first retail mechanism is the traditional “brick-and-mortar” approach, where customers will visit a physical store containing physical merchandise. Sales associates will be present in the store and can help customers make a selection and consummate a purchase. This is the manner in which commerce was conducted for centuries.

The second retail mechanism is e-commerce, which emerged only in the last thirty years, where customers visit a website operated by a retailer who may or may not also have a physical store. The customers browse through graphical depictions or digital photographs of merchandise. The customer selects an item electronically and consummates a purchase by providing credit card information, bank account information, or information required by other electronic payment mechanisms. There is no role for a sales associate in the e-commerce process, and the only recommendations and assistance provided to the customer are through computerized recommendation engines.

Both approaches have their benefits. The brick-and-mortar approach provides personal service and assistance to the customer and provides jobs for sales associates. The e-commerce approach provides an extremely fast way for customers to browse through virtual representations of physical items and can offer a larger number of items for view and purchase compared to a brick-and-mortar store.

Both approaches also have their downsides. In recent years, brick-and-mortar stores have failed in record numbers due to price competition from e-commerce sites. Sales associates at brick-and-mortar stores have been struggling with declining sales and commissions. To compete with e-commerce sites, sales associates at brick-and-mortar stores sometimes will communicate with customers using an electronic device running an application associated with the brick-and-mortar store outside of their normal work hours. This has caused an employment issue for some brick-and-mortar stores who have had to choose between compensating sales associates (or responding to claims from sales associates for compensation) for time spent communicating with customers outside of their normal work hours and shutting off access for sales associates to the retail server outside of the sales associates' normal hours (for example, by disabling the ability of the application to connect to the retail server). This sometimes has led to a situation where sales associates decide to then communicate with customers using third-party applications. In some instances, a sales associate will conduct business “on the side” by purchasing items from the retailer using his or her employee discount, and then re-selling the items at normal prices to the customer through the third-party application. This further harms the ability of brick-and-mortar stores to stay in business.

E-commerce sites have been financially successful. However, when shopping on an e-commerce site, the customer is not provided any assistance from sales associates and does not have the benefit of the expertise of sales associates who might have obtained tremendous knowledge about specific products by working in brick-and-mortar stores.

What is needed is an alternative approach to retail that provides the efficiency of e-commerce with the expertise and guidance of sales associates from brick and mortar stores. What is further needed is a mechanism for facilitating sales transactions using portable electronic devices operated by the customer and sales associate while also involving a retail server in the transaction.

### SUMMARY OF THE INVENTION

A method and apparatus are disclosed for facilitating retail transactions between a sales associate and a customer who are remote from one another and for providing a secure payment mechanism. Customers and sales associates each operate a software application on client devices that interact with a server. The software application enables a customer to find sales associates who are physically nearby and who have expertise in a product line of interest. The software application also allows a sales associate to find customers who are physically nearby and who are interested in a product line in which the sales associate has expertise. A customer and sales associate can communicate electronically and can consummate a purchase using a secure payment approval mechanism and subsequent payment mechanism provided by the software application. The sales associate can meet the customer in person to deliver the merchandise or the sales associate can arrange to have the merchandise shipped to the customer.

### BRIEF DESCRIPTION OF THE DRAWINGS

FIG. 1 depicts hardware components of a client device.

FIG. 2 depicts software components of the client device.

FIG. 3 depicts hardware components of a server.

FIG. 4 depicts software components of the server.

FIG. 5 depicts a plurality of client devices in communication with a server.

FIG. 6 depicts various software engines contained within a client application, a server application, or split between a client application and server application.

FIG. 7 depicts a customer home screen.

FIG. 8 depicts a customer login screen.

FIG. 9 depicts a customer registration screen.

FIG. 10 depicts a customer profile creation screen.

FIG. 11 depicts a customer profile entry screen.

FIG. 12 depicts another customer profile entry screen.

FIG. 13 depicts a tutorial screen.

FIG. 14 depicts a customer home screen.

FIG. 15 depicts a search screen.

FIG. 16 depicts a limited search screen.

FIGS. 17A and 17B depict an advanced search screen.

FIG. 18 depicts a search result screen.

FIG. 19 depicts a sales associate location screen.

FIG. 20 depicts a sales associate profile screen.

FIG. 21 depicts a sales associate details screen.

FIG. 22 depicts a sales associate history screen.

FIG. 23 depicts a messages screen.

FIG. 24 depicts a message chain screen.

FIG. 25 depicts a customer profile screen.

FIG. 26 depicts another customer profile screen.

FIG. 27 depicts a calendar screen.

FIG. 28 depicts a specific date screen.

FIG. 29 depicts a contacts screen.

FIG. 30 depicts a sales associate home screen.

FIG. 31 depicts a calendar screen.

FIG. 32 depicts a specific date screen.

FIG. 33 depicts a contacts screen.

FIG. 34 depicts a messages screen.

FIG. 35 depicts a message chain screen.

FIG. 36 depicts a customer profile screen.

FIG. 37 depicts a customer notes screen.

FIG. 38 depicts a customer posts screen.

FIGS. 39A and 39B depict a customer history screen.

FIG. 40 depicts a sales associate profile screen.

FIG. 41 depicts a sales associate details screen.

FIG. 42 depicts a sales associate ratings screen.

FIG. 43 depicts a customer item approval screen.

FIG. 44 depicts a sales associate invoice creation screen.

FIG. 45 depicts a sales associate completed invoice screen.

FIG. 46 depicts a sales associate authentication screen

FIG. 47 depicts a customer invoice receipt screen.

FIG. 48 depicts a customer invoice approval screen.

FIG. 49 depicts a customer authentication screen.

FIG. 50 depicts a customer encoded payment information screen.

FIG. 51 depicts a sales associate invoice confirmation screen.

FIG. 52 depicts a sales associate payment finalization screen.

### DETAILED DESCRIPTIONS OF THE PREFERRED EMBODIMENTS

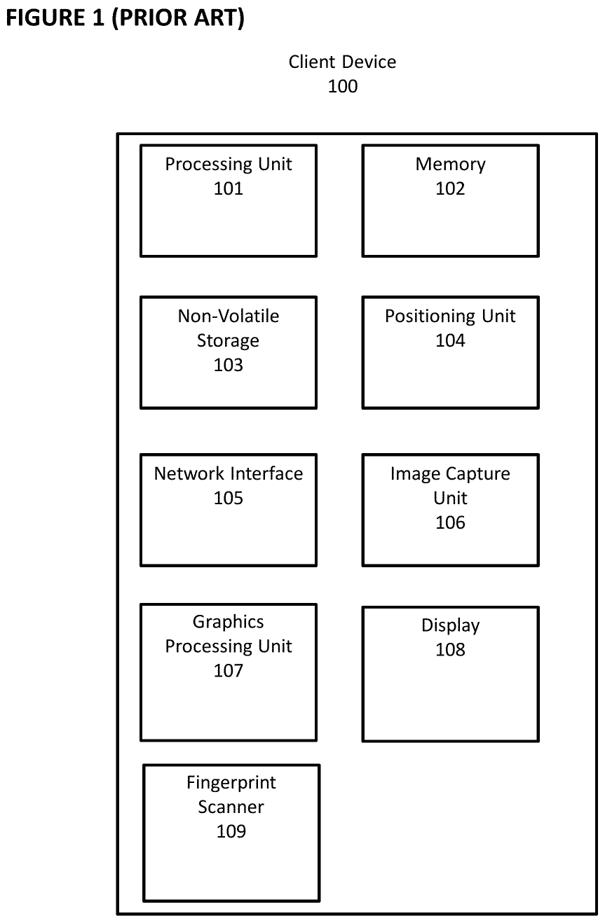

FIG. 1 depicts hardware components of client device 100. These hardware components are known in the prior art. Client device 100 is a computing device that comprises processing unit 101 memory 102, non-volatile storage 103, positioning unit 104, network interface 105, image capture unit 106, graphics processing unit 107, display 108, and fingerprint scanner 109. Client device 100 can be a smartphone, notebook computer, tablet, desktop computer, gaming unit, wearable computing device such as a watch or glasses, or any other computing device.

Processing unit 101 optionally comprises a microprocessor with one or more processing cores. Memory 102 optionally comprises DRAM or SRAM volatile memory. Non-volatile storage 103 optionally comprises a hard disk drive or flash memory array. Positioning unit 104 optionally comprises a GPS unit or GNSS unit that communicates with GPS or GNSS satellites to determine latitude and longitude coordinates for client device 100, usually output as latitude data and longitude data. Network interface 105 optionally comprises a wired interface (e.g., Ethernet interface) or wireless interface (e.g., 3G, 4G, GSM, 802.11, protocol known by the trademark BLUETOOTH, etc.). Image capture unit 106 optionally comprises one or more standard cameras (as is currently found on most smartphones and notebook computers). Graphics processing unit 107 optionally comprises a controller or processor for generating graphics for display. Display 108 displays the graphics generated by graphics processing unit 107, and optionally comprises a monitor, touchscreen, or other type of display. Fingerprint scanner 109 is an input device that can capture a human fingerprint.

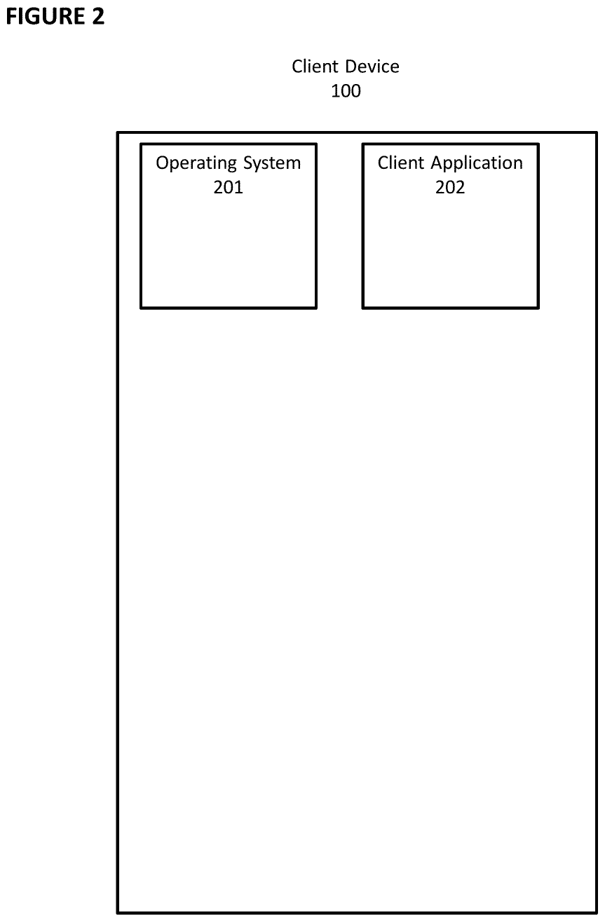

FIG. 2 depicts software components of client device 100. Client device 100 comprises operating system 201 (such as one of the operating systems known by the trademarks WINDOWS, LINUX, ANDROID, or IOS) and client application 202. Client application 202 comprises lines of software code executed by processing unit 101 and/or graphics processing unit 107 to perform the functions described below. For example, client device 100 can be a smartphone sold with the trademark GALAXY by Samsung or IPHONE by Apple, and client application 202 can be a downloadable application (app) installed on the smartphone or a website browser running code obtained from server 300 (described below). Client device 100 also can be a notebook computer, desktop computer, game system, or other computing device, and client application 202 can be a software application running on client device 100 or a website browser on client device 100 running code obtained from server 300. Client application 202 forms an important component of the inventive aspect of the embodiments described herein, and client application 202 is not known in the prior art.

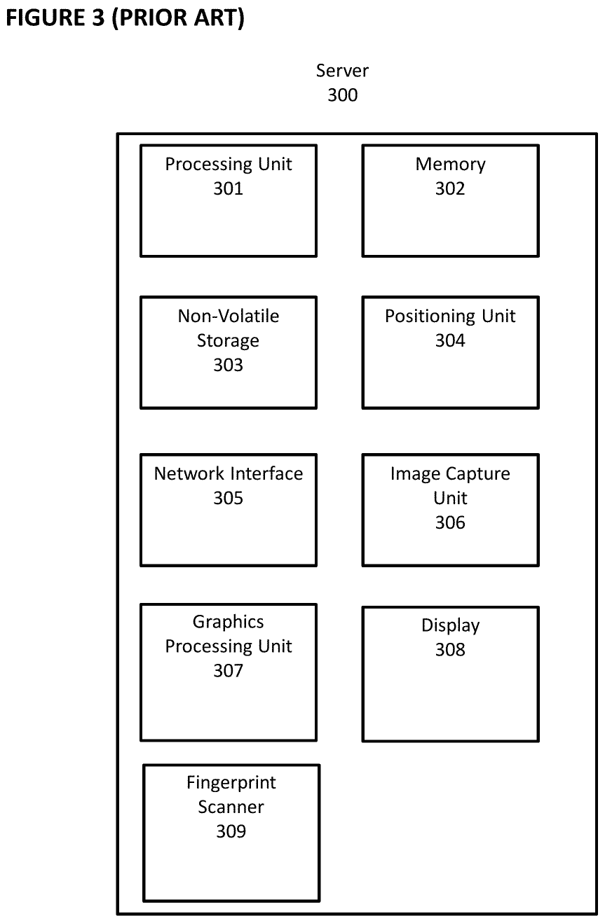

FIG. 3 depicts hardware components of server 300. These hardware components are known in the prior art. Server 300 is a computing device that comprises processing unit 301, memory 302, non-volatile storage 303, positioning unit 304, network interface 305, image capture unit 306, graphics processing unit 307, display 308, and fingerprint scanner 309. Server 300 can be a general-purpose server, a special-purpose server, a notebook computer, tablet, desktop computer, or any other computing device capable of performing server-client functions with client device 100.

Processing unit 301 optionally comprises a microprocessor with one or more processing cores. Memory 302 optionally comprises DRAM or SRAM volatile memory. Non-volatile storage 303 optionally comprises a hard disk drive or flash memory array. Positioning unit 304 optionally comprises a GPS unit or GNSS unit that communicates with GPS or GNSS satellites to determine latitude and longitude coordinates for server 300, usually output as latitude data and longitude data. Network interface 305 optionally comprises a wired interface (e.g., Ethernet interface) or wireless interface (e.g., 3G, 4G, GSM, 802.11, protocol known by the trademark BLUETOOTH, etc.). Image capture unit 306 optionally comprises one or more standard cameras (as is currently found on most smartphones and notebook computers). Graphics processing unit 307 optionally comprises a controller or processor for generating graphics for display. Display 308 displays the graphics generated by graphics processing unit 307, and optionally comprises a monitor, touchscreen, or other type of display. Fingerprint scanner 309 is an input device that can capture a human fingerprint.

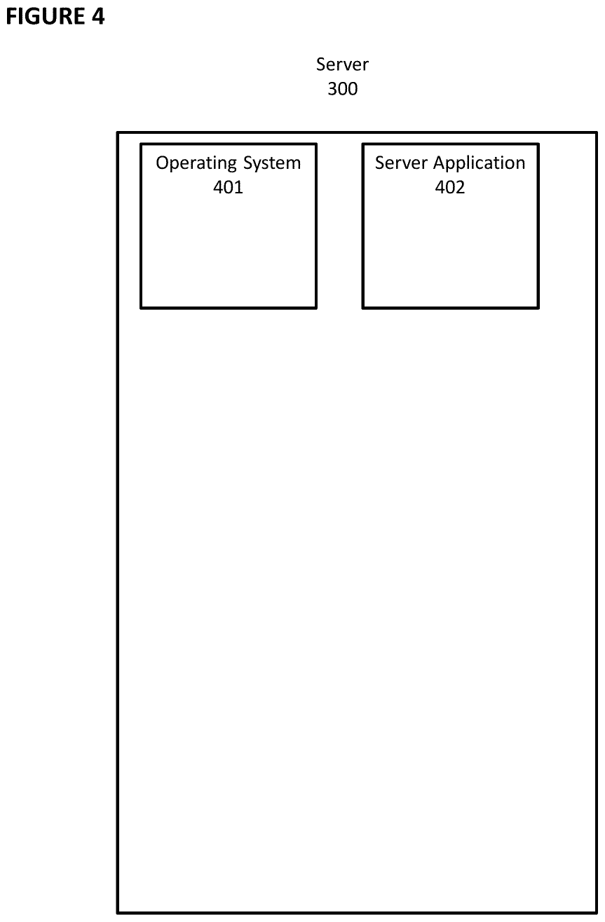

FIG. 4 depicts software components of client device 100. Server 300 comprises operating system 301 (such as one of the server operating systems known by the trademarks WINDOWS SERVER, LINUX, or MAC OS X SERVER) and server application 402. Server application 402 comprises lines of software code executed by processing unit 301 and/or graphics processing unit 307 to perform the functions described below. Server application 402 forms an important component of the inventive aspect of the embodiments described herein, and client application 202 is not known in the prior art.

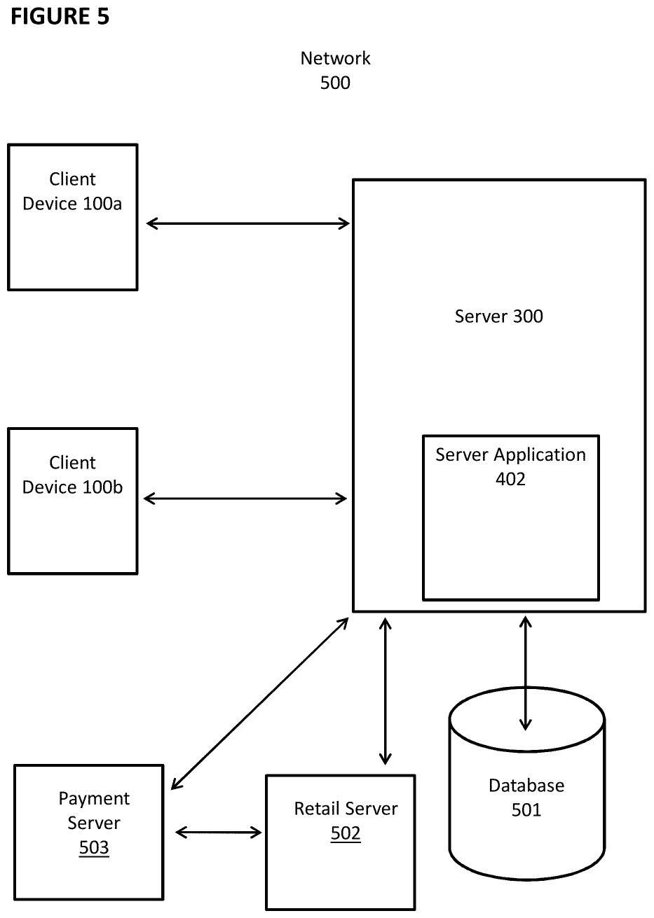

FIG. 5 depicts exemplary network 500 comprising two instantiations of client device 100, client devices 100a and 100b, communicating with server 300. These are exemplary devices, and it is to be understood that any number of different instantiations of client device 100 can be used.

Client devices 100a and 100b each communicate with server 300 using network interface 150. Server 300 runs server application 402. Server application 402 comprises lines of software code that are designed specifically to interact with client application 202.

Server 300 optionally comprises or is coupled to database 501. Database 501 can be used to store profile information, authentication information, web page files, retail data, ratings data, preference data, and other data needed for performing the functions described herein.

Optionally, server 300 also communicates with retail server 502, which might be a server operated for a brick-and-mortar store or a server for an e-commerce site. Server 300 and retail server 502 also can communicate with payment server 503, which might be a server operated by a credit card company (such as the company known by the trademark VISA), a bank (such as the bank known by the trademark CITI), or electronic payment service (such as the service known by the trademark PAYPAL), or other payment service.

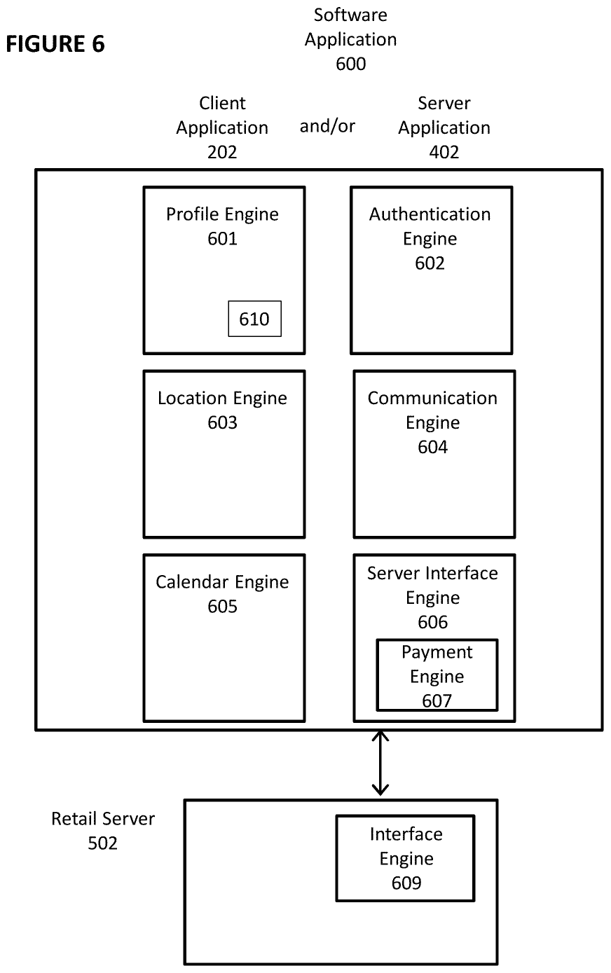

FIG. 6 depicts software application 600, which comprises profile engine 601, authentication engine 602, location engine 603, communication engine 604, calendar engine 605, and server interface engine 606. Server interface engine 606 comprises payment engine 607.

Software application 600 can comprise only client application 202, only server application 402, or can be split between client application 202 and server application 402. In other words, software application 600 can be distributed between client application 202 and server application 402.

Profile engine 601, authentication engine 602, location engine 603, communication engine 604, calendar engine 605, server interface engine 606, and payment engine 607 each comprises lines of software code executed by processing unit 101, processing unit 301, graphics processing unit 107, and/or graphics processing unit 307, and/or comprises additional integrated circuitry, to perform functions described herein. For example, payment engine 607 might comprise additional integrated circuitry for performing encryption or hash functions.

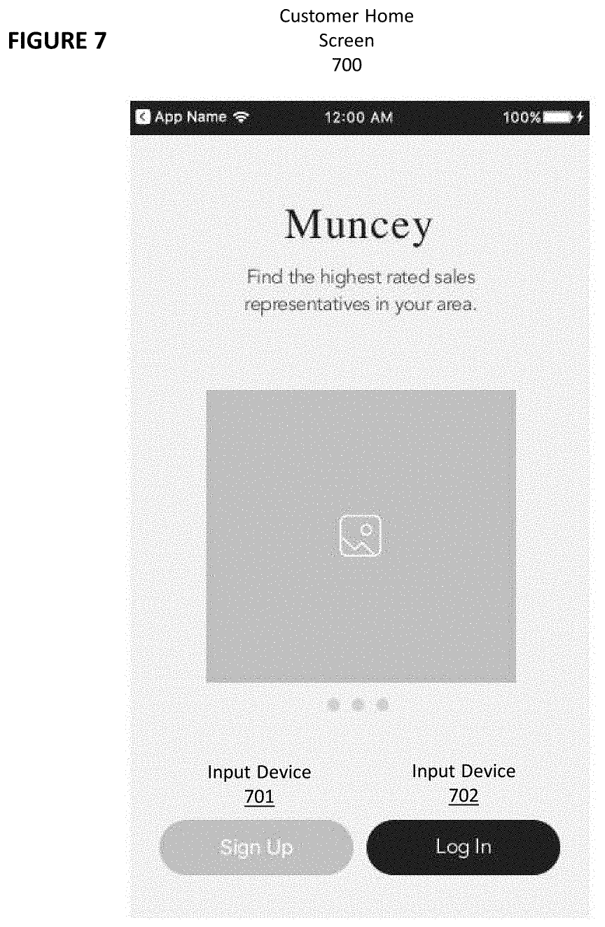

The functions performed by profile engine 601, authentication engine 602, location engine 603, communication engine 604, calendar engine 605, server interface engine 606, and payment engine 607 will now be described in greater detail with reference to FIGS. 7-52, which depict an embodiment of the invention to facilitate retail transactions between a customer and a sales associate and to provide a secure payment approval mechanism and payment mechanism for purchases.

In this example, an exemplary customer (whose name is Abby Smith) operates client device 100a, and an exemplary sales associate (whose name is Lindsey Grand) operates client device 100b. Exemplary profile record 610 is created and maintained by profile engine 601 for the exemplary customer (Abby Smith).

Functionality Provided to Client Device 100a Operated by the Customer

The embodiment will now be described from the perspective of the exemplary customer (Abby Smith) operating client device 100a.

FIG. 7 depicts customer home screen 700 that is generated on display 108 of client device 100a by software application 600. Customer home screen 700 is the starting page for the customer. This screen provides input device 701 to enable the customer to register and create a customer profile with server 300 and input device 702 to enable the customer to log in to server 300 if the customer already has registered and created a customer profile with server 300. Here, input devices 701 and 702 are buttons, which are types of input devices that are known to persons of ordinary skill in the art. Other known input devices for a graphical user interface environment such as this one include links, menus, text boxes, and selection boxes. It is to be understood that input devices 701 and 702 can be implemented using any known input devices. The same is true for any other input devices described herein.

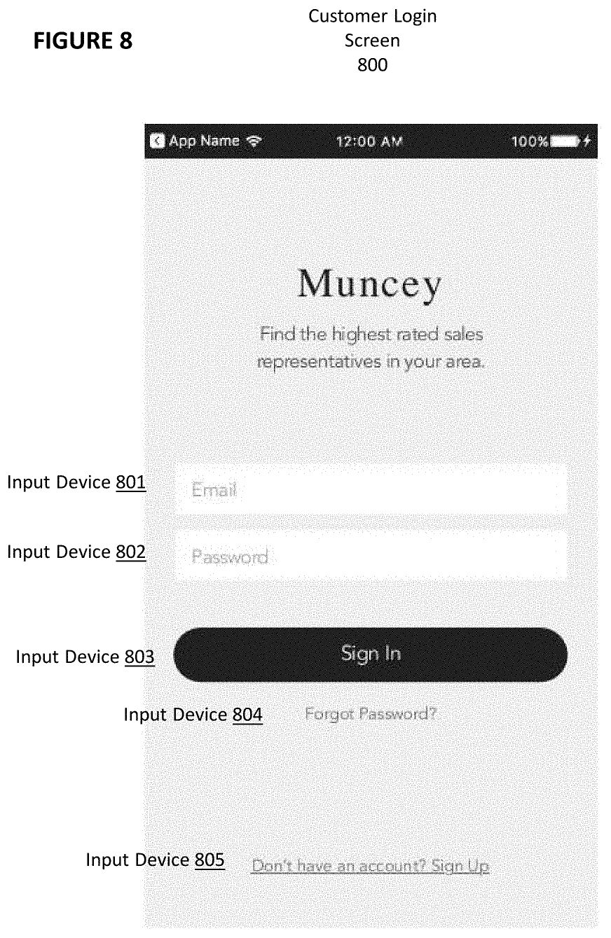

FIG. 8 depicts customer registration screen 800 that is generated on display 108 of client device 100a by software application 600 if the customer selects input device 702 on customer home screen 700. Customer registration screen 800 provides input device 801 to enable the customer to enter a user name or email address, input device 802 to enable the customer to enter a password, input device 804 to allow a customer to change the password if the customer has forgotten it, and input device 805 if the customer needs to first create and register a profile.

Input device 803, when selected by the customer, will cause the information entered into input devices 801 and 802 to be transmitted to authentication engine 602. If authentication engine 602 finds a match between the information entered into input devices 801 and 802 and any known customer name/email address and password previously stored by profile engine 601, it will allow the customer to log in to software application 600 as an authentic customer. However, if authentication engine 602 does not find a match, it will re-generate screen 800 and ask the customer to enter his or her customer name or email address and password again.

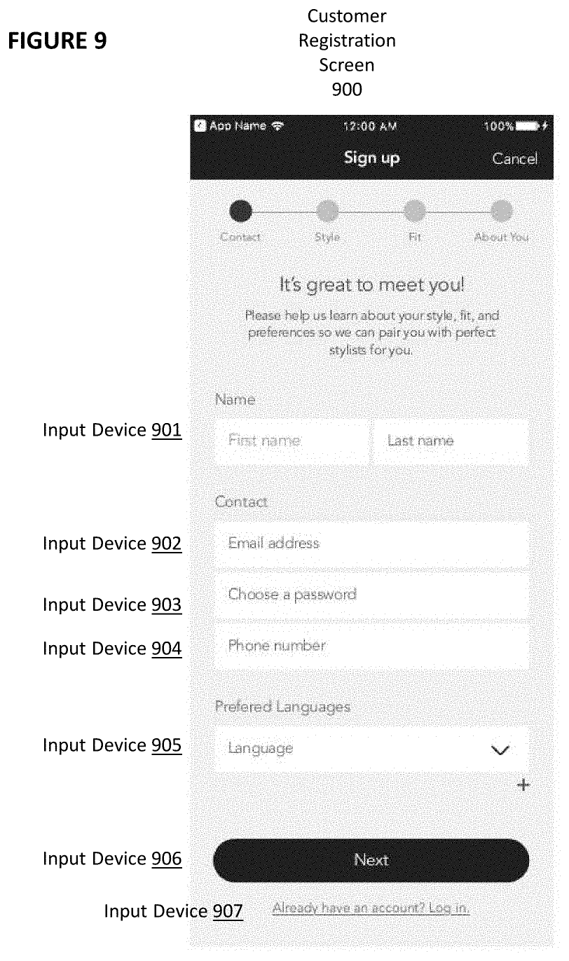

FIG. 9 depicts customer registration screen 900 that is generated on display 108 of client device 100a by client application 202 if the customer selects input device 701 on exemplary screen 700 or input device 805 on exemplary screen 800.

Exemplary screen 900 enables a customer to register and create a profile with server 300. It provides input device 901 to enable the customer to enter his or her name, input device 902 to enable the customer to enter an email address, input device 903 to enable a customer to enter a password, input device 904 to enable the customer to enter a phone number, input device 905 to enable the customer to enter his or her preferred language, and input device 907 if the customer already has created and registered a profile and wishes to log on (in which case exemplary screen 800 can then be generated on display 108 of client device 100). Input device 906, when selected by the customer, will cause the information entered into input devices 901, 902, 903, 904, and 905 to be transmitted to profile engine 601, which will create exemplary profile record 610 and will add the collected information to profile record 610. Profile record 610 optionally can be stored in non-volatile storage 103, non-volatile storage 303, database 501, or elsewhere.

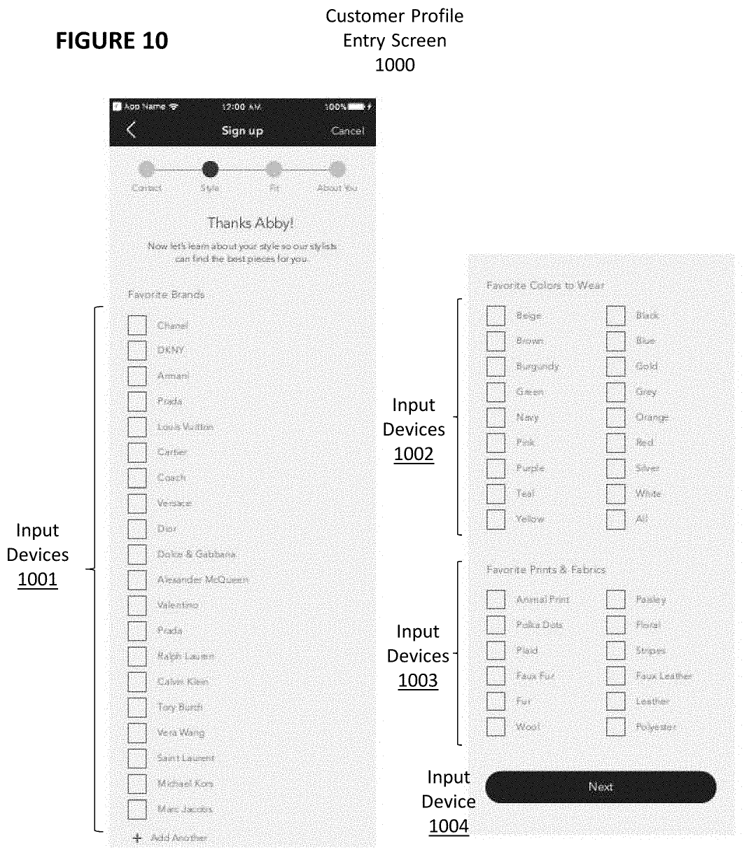

FIG. 10 depicts customer profile entry screen 1000 that is generated on display 108 of client device 100a by software application 600 after the customer has selected input device 906 on screen 900. Input devices 1001, 1002, and 1003 allow a customer to indicate his or her favorite brands of retail clothing items, favorite color for retail clothing items, and favorite prints and fabrics for retail clothing items, respectively. Input device 1004, when selected by the customer, will transmit the information entered into input devices 1001, 1002, and 1003 to profile engine 601, which will add the collected information to profile record 610.

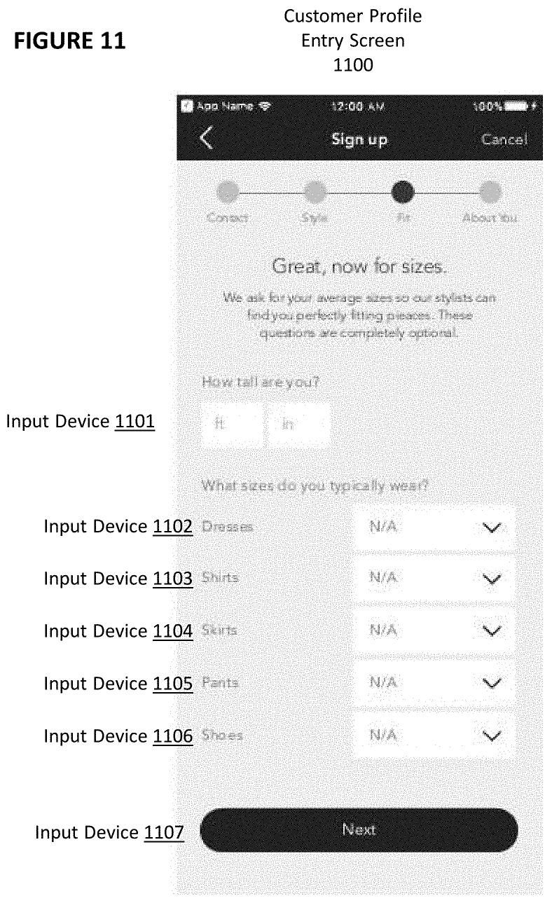

FIG. 11 depicts customer profile entry screen 1100 that is generated on display 108 of client device 100a by software application after the customer has selected input device 1004 on screen 1000. Input devices 1101, 1102, 1103, 1104, 1105, and 1106 allow a customer to enter his or her height information, dress size, shirt size, skirt size, pants size, and shoe size, respectively. Input device 1107, when selected by the customer, will transmit the information entered into input devices 1101, 1102, 1103, 1104, 1105, and 1106 to profile engine 601, which will add the collected information to profile record 610.

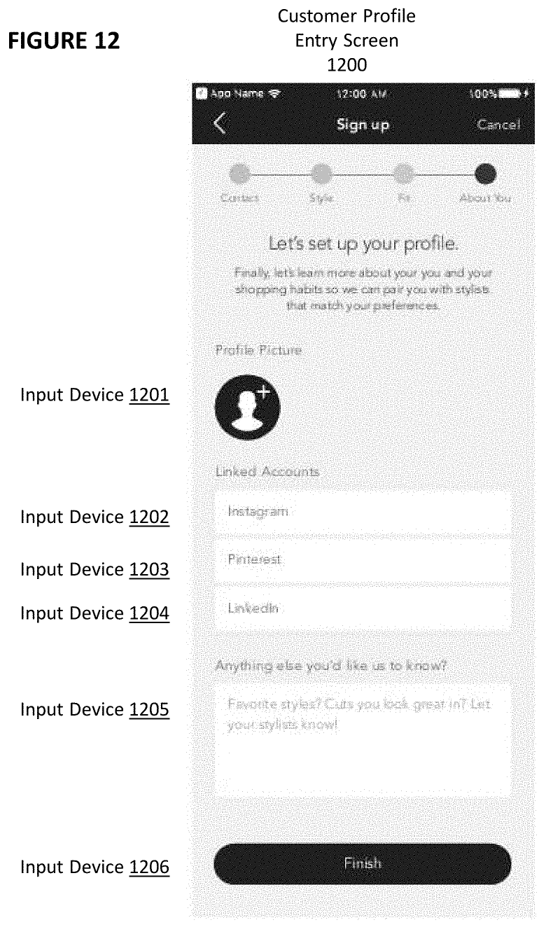

FIG. 12 depicts customer profile entry screen 1200 that is generated on display 108 of client device 100a by software application 600 after the customer has selected input device 1107 on screen 1100. Input device 1201 allows a customer to enter a profile photo. Input devices 1202, 1203, and 1204 allow the customer to enter account names for other apps or online services, such as the social networking services known by the trademarks INSTAGRAM, PINTEREST, and LINKEDIN. Input device 1205 allows the customer to enter other information that he or she wishes for retailers to know. Input device 1206, when selected by the customer, will transmit the information entered into input devices 1201, 1202, 1203, 1204, and 1205 to profile engine 601, which will add the collected information to profile record 610. This completes the customer registration and profile creation process.

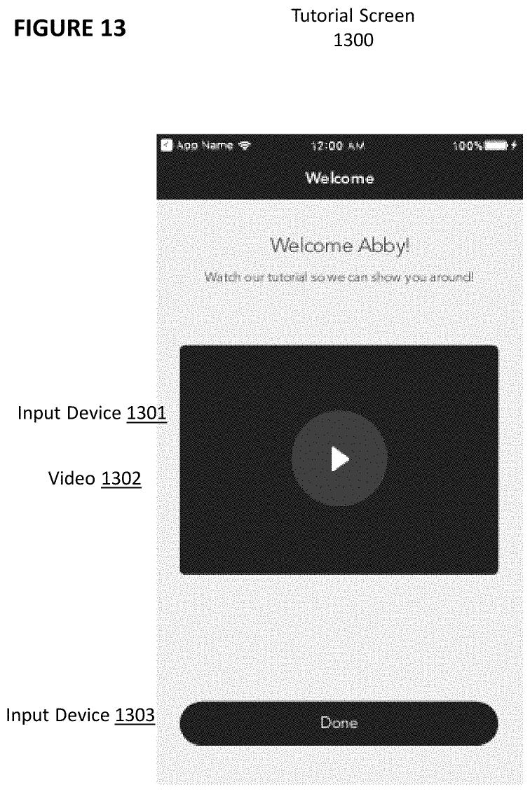

FIG. 13 depicts tutorial screen 1300 that is generated on display 108 of client device 100s by software application 600 after the customer has selected input device 1206 on screen 1200. Input device 1301 allows a customer to begin playing video 1302, which in this example is a video tutorial explaining how to use software application 600. Input device 1303 can be selected by the customer when or she is finished watching video 1302.

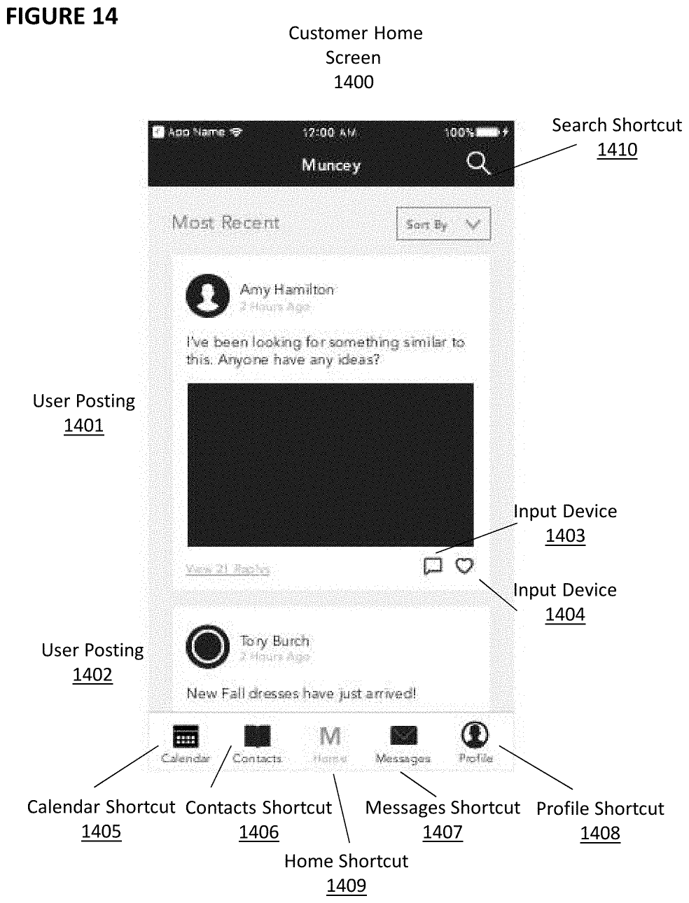

FIG. 14 depicts customer home screen 1400. This can be the first screen a customer sees after logging into the application through customer login screen 800 in FIG. 8 and is authenticated by authentication engine 602. Customer home screen 1400 depicts postings by users (who might be customers, sales associates, retail entities, or other persons or entities) who are on the customer's contacts list. Here, user posting 1401 from Amy Hamilton is displayed. The customer can comment on user posting 1402 using input device 1403, which will allow the customer to post a comment. The user also can indicate that he or she likes user posting 1401 by selecting input device 1404, which will post a like indication. A portion of user posting 1402 also is displayed. The customer optionally can scroll down to see additional user postings. The postings are managed by communication engine 604.

Customer home screen 1400 further includes calendar shortcut 1405, contacts shortcut 1406, message shortcut 1407, profile shortcut 1408, and search shortcut 1410, which, when selected by the customer, will launch calendar screen 2700, contacts screen 2900, messages screen 2300, customer profile screen 2500, and search screen 1500, respectively.

Home screen 1400 also includes home screen shortcut 1409. Normally, selecting home screen shortcut 1409 would launch customer home screen 1400. However, because customer home screen 1400 already is being displayed, home screen shortcut 1409 is disabled on this particular screen.

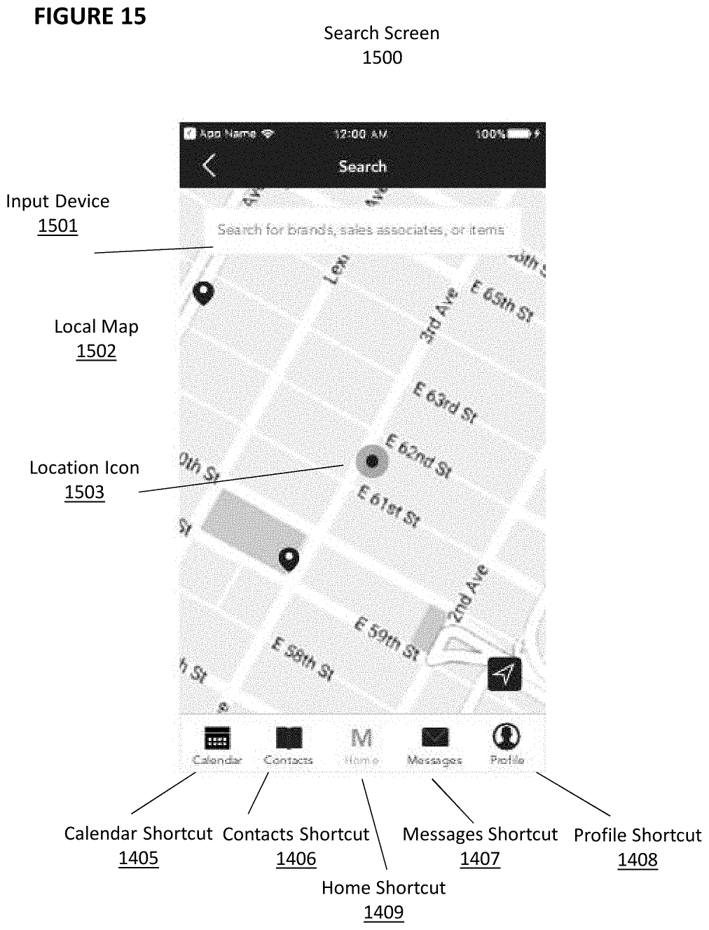

FIG. 15 depicts search screen 1500. Search screen depicts local map 1502, which shows a map of the local area around client device 100 and is generated by location engine 603. Within local map 1502, location icon 1503 indicates the location of client device 100a, which is determined using positioning unit 104 in client device 100a. Input device 1501 allows a customer to input search parameters, such as the name of a retail brand, a sales association, a retail item, or an address.

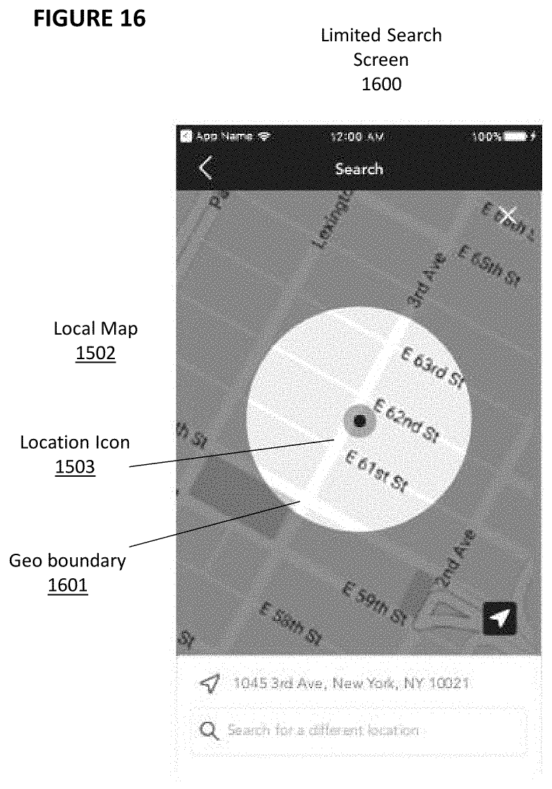

FIG. 16 depicts limited search screen 1600. Limited search screen 1600 is similar to search screen 1500 except that the customer is able to establish a geo-boundary 1601 of X distance (e.g., ¼ of a mile) around the location of computing device 100a, such that the search is limited to the area that is no farther than X distance away from the present location of customer device 100a and the customer.

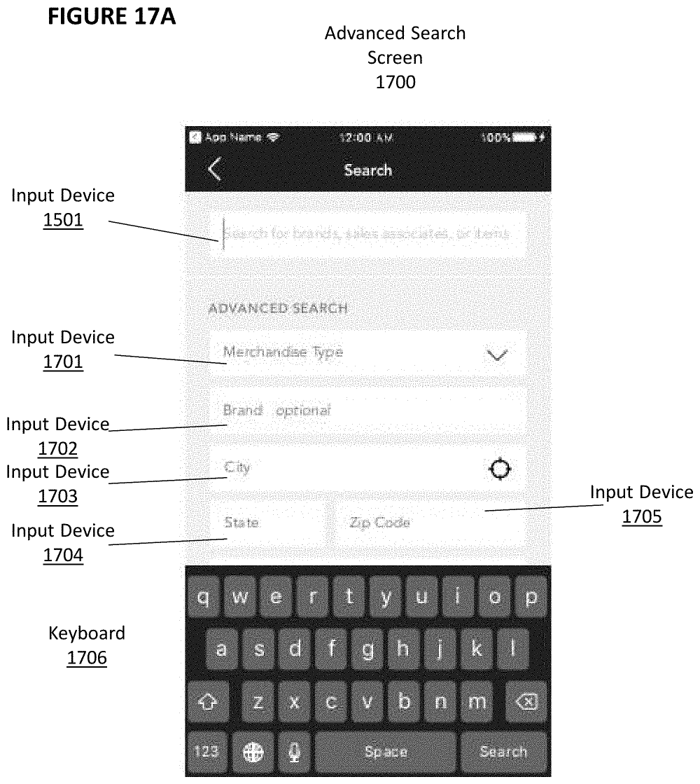

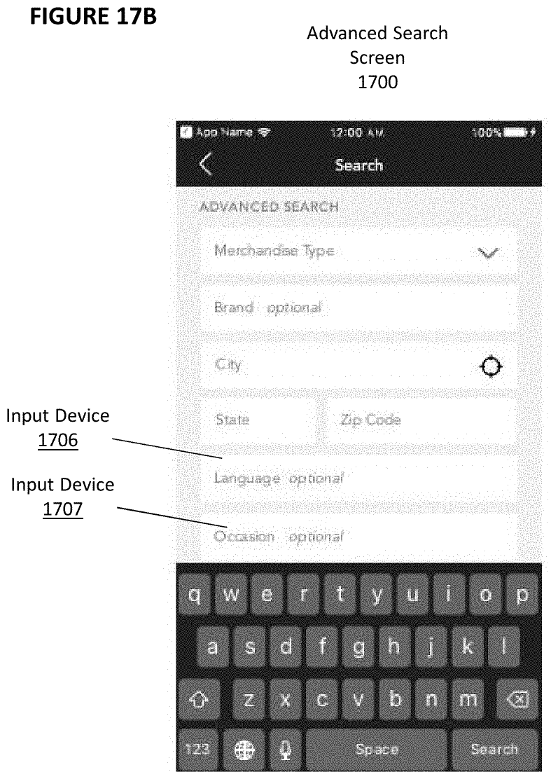

FIGS. 17A and 17B depict advanced search screen 1700, which includes keyboard 1706 and input devices 1701, 1702, 1703, 1704, 1705, 1706, and 1707, which in this example, can be used by the customer to enter search parameters for merchandise type, brand, city, state, zip code, language spoken or preferred by the customer, and occasion (e.g. a friend's birthday), respectively.

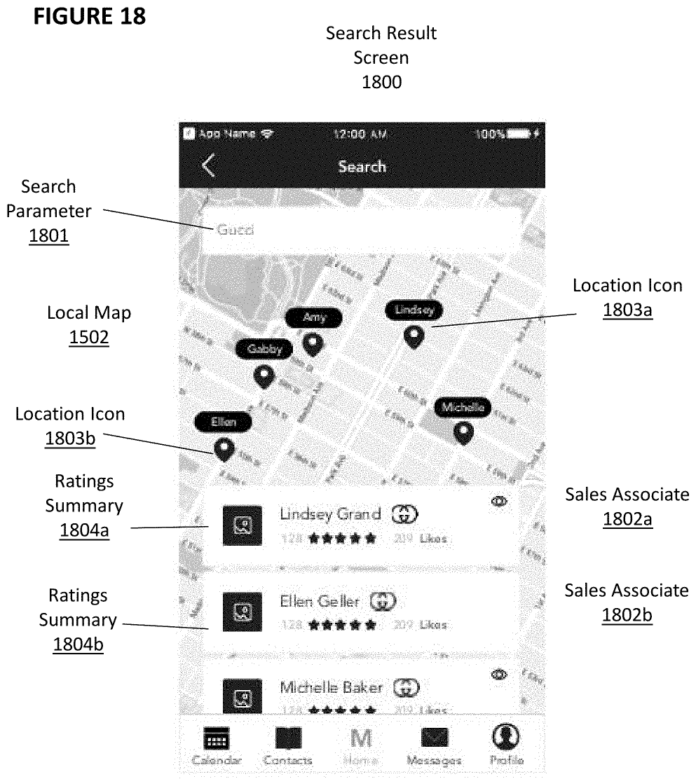

In response to a search entered on limited search screen 1600 or advanced search screen 1700, profile engine 601 will search through all profile records of sales associates based on the search criteria. FIG. 18 depicts search result screen 1800. Here, the search results are generate by profile engine 601 in response to search parameter 1801 (“Gucci”), which the customer had previously entered in input device 1501 or input device 1702. Location Engine 603 keeps track of the location of every client device 100 that is operating software application 600. Profile engine 601 performs a search within all profile records to identify sales associates who are associated with search parameter 1801 (for example, sales associates who have indicated in their sales associate profiles that they carry “Gucci” merchandise). Location engine 603 provides the location of each client device 100 operated by each sales associate who is associated with search parameter 1801. For each such sales associate who is located within the area depicted in local map 1502, a location icon will be generated to show the location of the computing device 100 operated by the sales associate within local map 1502 and a ratings summary for that sales associate will be displayed.

In this example, sales associate 1802a (who is the exemplary sales associate of this example, and whose name is Lindsey Grand) is located within the area displayed in local map 1502. Location icon 1803a indicates the location of sales associate 1802a within local map 1502, and ratings summary 1804a contains a rating summary for sales associate 1802a, which here includes the average star rating entered for sales associate 1802a by each customer who has interacted with sales associate 1802a, and a “likes” total that indicates the number of customers who have submitted a “like” for sales associate 1802a.

Similarly, sales associate 1802b (whose name is Ellen Geller) is located within the area displayed in local map 1502. Location icon 1803b indicates the location of sales associate 1802b within local map 1502, and ratings summary 1804b contains a rating summary for sales associate 1802b, which here includes the average star rating entered for sales associate 1802b by each customer who has interacted with sales associate 1802b, and a “likes” total that indicates the number of customers who have submitted a “like” for sales associate 1802b.

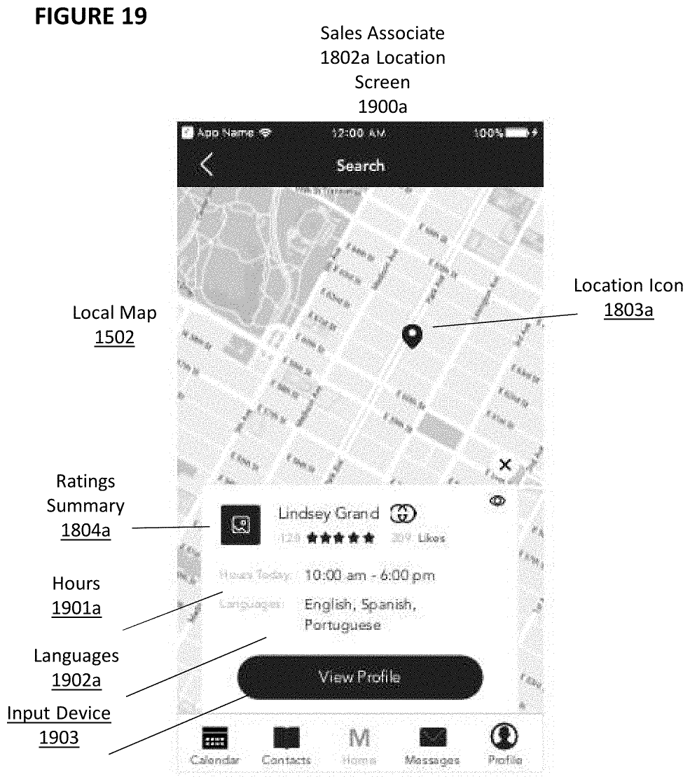

FIG. 19 depicts sales associate 1802a location screen 1900a, which is generated if the customer selects sales associate 1802a in screen 1800. Location icon 1803a shows the location of sales associate 1802a within local map 1502. Also displayed are hours 1901a (which shows the hours in which sales associate 1802a is working today) and languages 1902a (which indicate the languages spoken by sales associate 1802a). Input device 1903, when selected by a customer, will display a profile for sales associate 1802a.

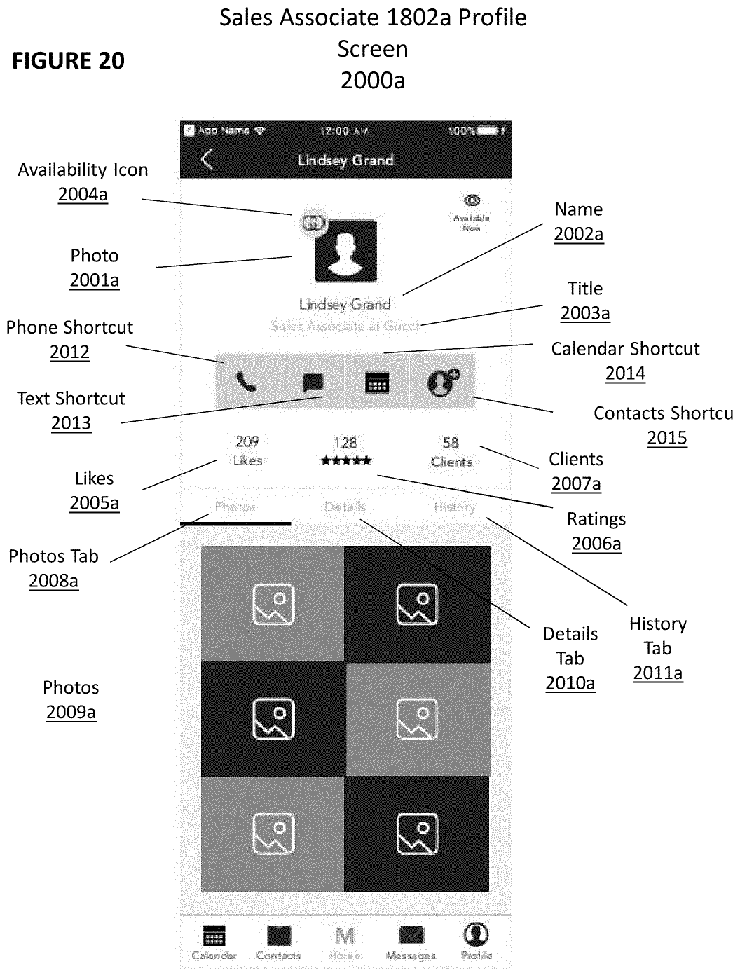

FIG. 20 depicts sales associate 1802a profile screen 2000a, which is displayed in response to input device 1903 being selected and includes additional information about sales associate 1802, including photo 2001a, name 2002a, title 2003a, availability icon 2004a, likes 2005a, ratings 2006a, clients 2007a, photos tab 2008a, details tab 2010a, history tab 2011a, phone shortcut 2012, text shortcut 2013, calendar shortcut 2014, and contacts shortcut 2015.

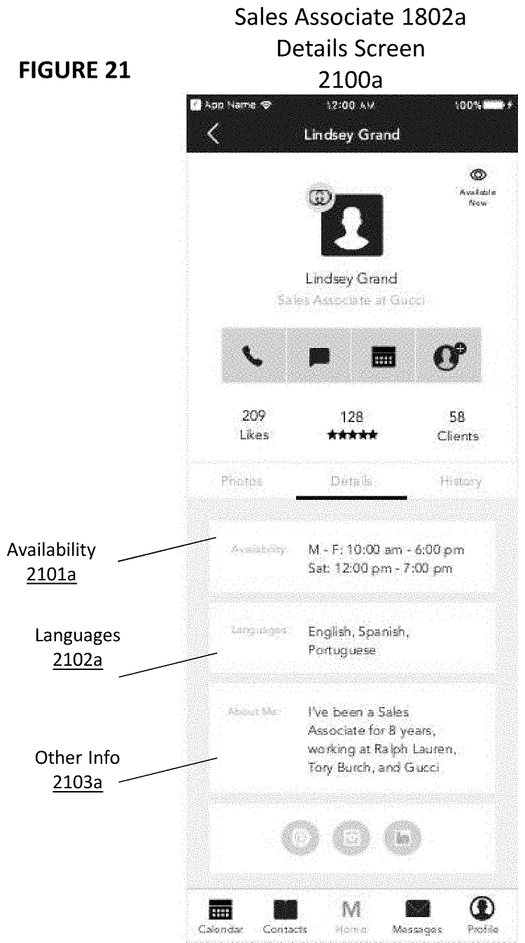

FIG. 21 depicts sales associate 1802a details screen 2100a, which is displayed in response to the customer selecting details tab 2010a and includes availability 2101a, languages 2102a, and other info 2103a.

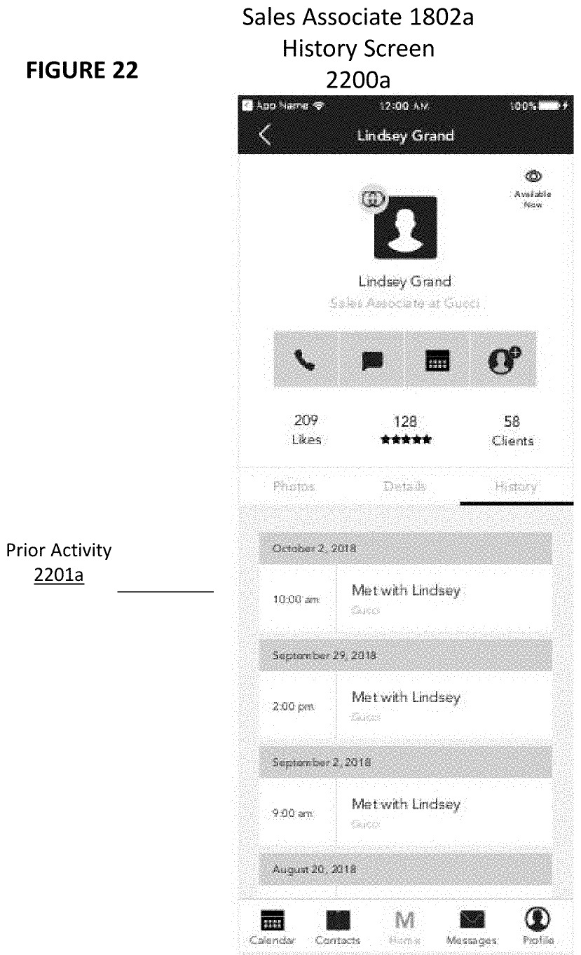

FIG. 22 depicts sales associate 1802a history screen 2100a, which is displayed in response to the customer selecting history tab 2011a, and indicates prior activity 2201a for sales associate 1802a.

When the customer finds a sales associate, such as Lindsey Grand, who seems like a person who can assist that customer, the customer can then initiate contact with the sales associate by sending the sales associate a message or calling the sales associate on the phone.

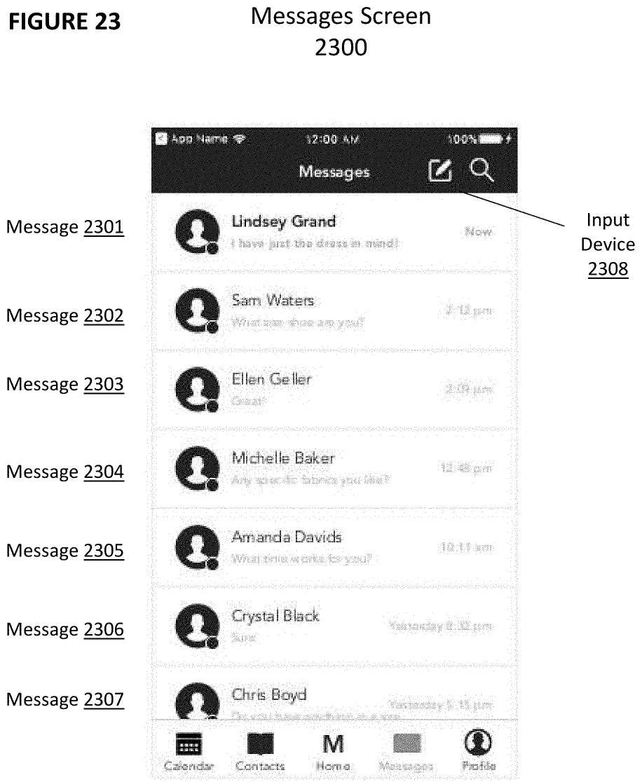

FIG. 23 depicts messages screen 2300, which is displayed in response to the customer selecting a messages shortcut such as message shortcut 1407. Messages screen 2300 depicts messages 2301, 2302, 2303, 2304, 2305, 2306, and 2307 sent to the customer Message screen 2300 also includes input device 2308, which, when selected by the customer, will allow the customer to draft a new message. For instance, if the customer wants to initiate contact with sales associate Lindsey Grand, he or she could send a message (e.g., “I am interested in Gucci purses for a formal event. Do you have any in stock that you would recommend?”

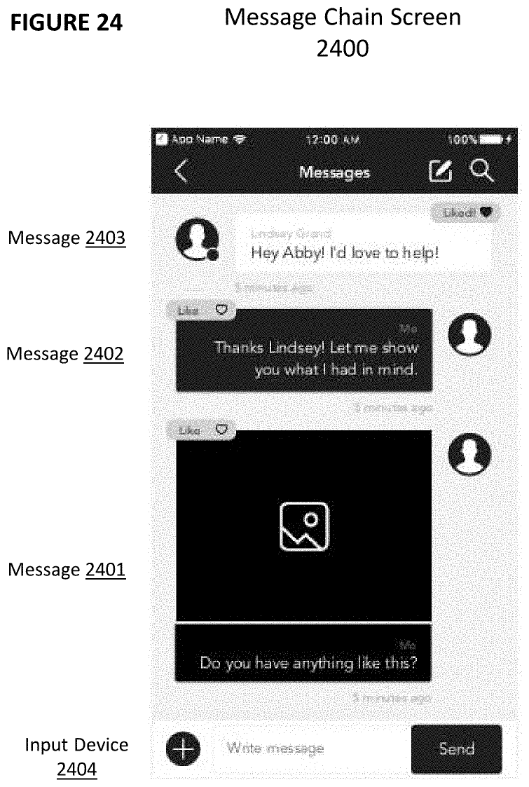

FIG. 24 depicts message chain screen 2400, which is displayed when the customer selects a particular message on messages screen 2300. This screen depicts messages sent in a messages chain between the customer and a sales associate (Lindsey Grand), which comprise messages 2401, 2402, and 2403. The customer optionally can send another message to the sales associate using input device 2404.

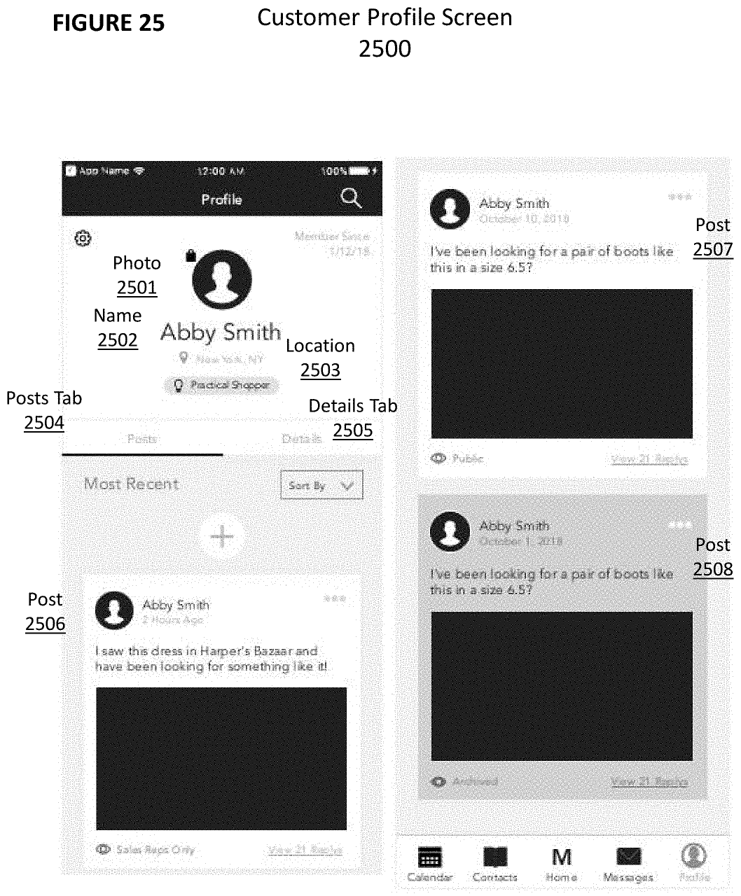

FIG. 25 depicts customer profile screen 2500, which is displayed when the customer selects profile shortcut 1408. Profile screen 2500 includes photo 2501, name 2502, location 2503, posts tab 2504, and details tab 2505. When posts tab 2504 is active or is selected, posts of the user such as posts 2506, 2507, and 2508 are displayed.

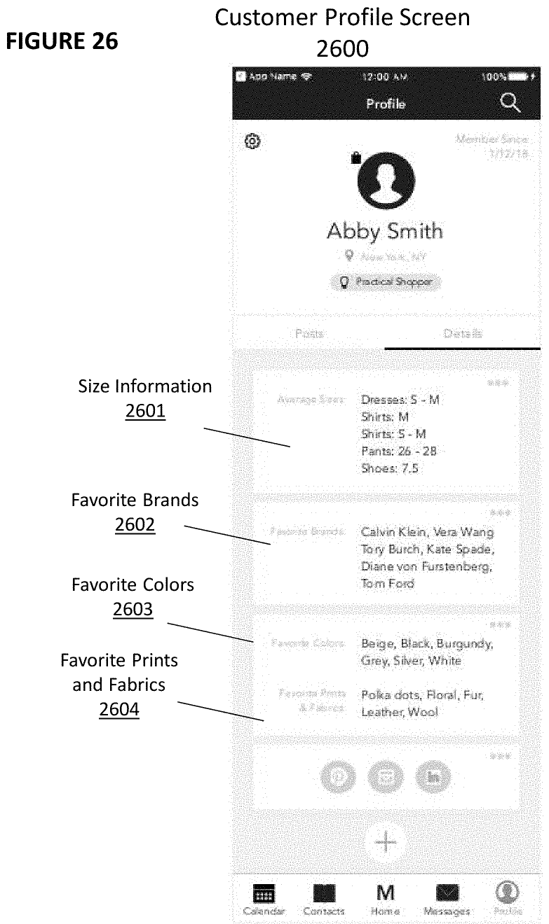

FIG. 26 depicts customer profile screen 2600, which is displayed when the customer selects details tab 2505. Details tab 2505 displays certain information in profile record 610 for the customer, including size information 2601, favorite brands 2602, favorite colors 2603, and favorite prints and fabrics 2604. The customer profile optionally can be viewed by all registered sales associates, which would enable sales associates to perform searches to find customers in close proximity to the sales associate who are interested in the type of merchandise that the sales associate handles.

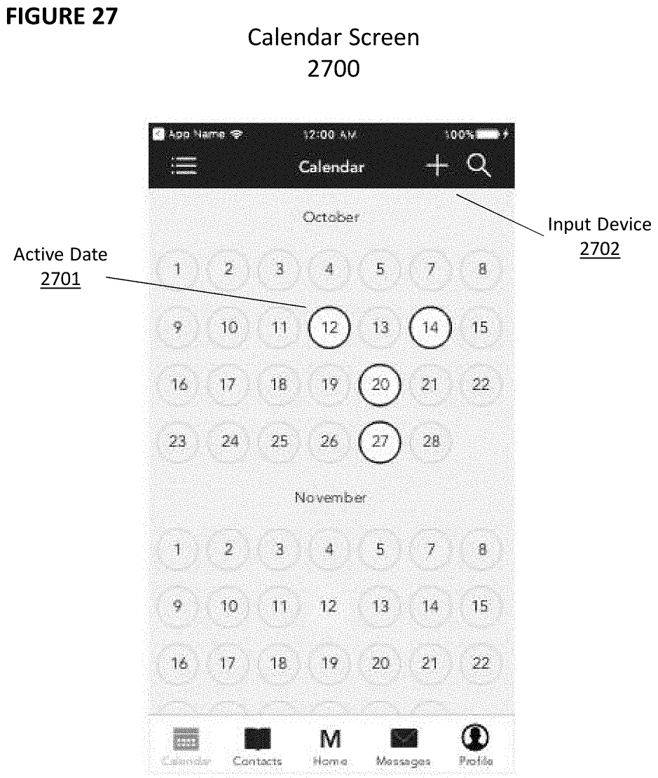

FIG. 27 depicts calendar screen 2700, which is displayed when the customer selects a calendar shortcut such as calendar shortcut 1405. Calendar screen 2700 depicts active date 2701, which here is a date containing a calendar entry (such as an appointment). Other active dates are shown and are indicated with white circles similar to active date 2701. Input device 2702 allows a user to create a new calendar entry. This feature can be useful if a customer and sales associate want to schedule a physical meeting or a phone call.

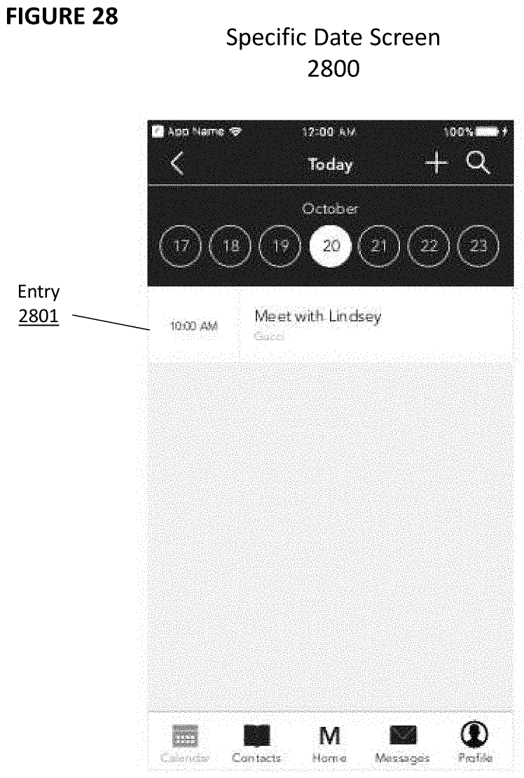

FIG. 28 depicts specific date screen 2800, which is displayed when a user selects a specific date on calendar screen 2700. This particular date screen 2800 is for October 20. It displays entry 2801, which is an appointment at 10 am, described as “Meet with Lindsey.”

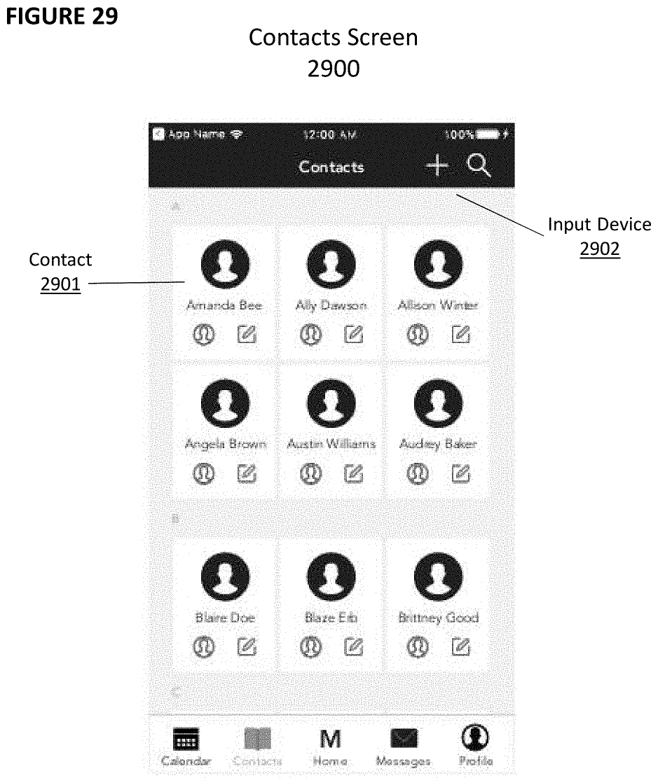

FIG. 29 depicts contacts screen 2900, which is displayed when the customer selects contacts shortcut 1406. This screen displays all contacts for the customer, such as exemplary contact 2901. Contact 2901 shows a name and photo for the contact.

Functionality Provided to Client Device 100b Operated by the Sales Associate

The embodiment will now be described from the perspective of the exemplary sales associate operating client device 100b, which here is sales associate 1802a (Lindsey Grand).

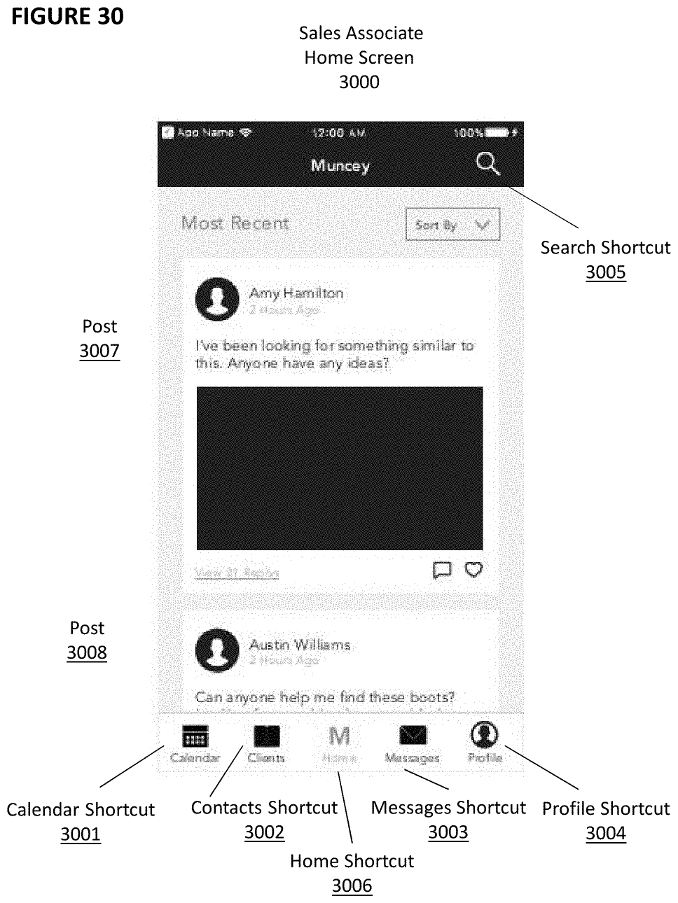

FIG. 30 depicts sales associate home screen 3000. This can be the first screen a sales associate sees after logging in to software application 600. The registration, profile entry, and login steps can be the same or similar for sales associates as for customers (as described previously with respect to FIGS. 7-12), and for efficiency's sake, those steps and related screens will not be described here. One of ordinary skill in the art will appreciate that the profile entry process for a sales associate might request different types of information than the profile entry process for a customer.

Sales associate home screen 3000 depicts postings by users (who might be customers, sales associates, or others) who are on the sales associate's contacts list, such as posts 3007 and 3008. The postings are managed by communication engine 604. Sales associate home screen 3000 includes calendar shortcut 3001, contacts shortcut 3002, message shortcut 3003, profile shortcut 3004, and search shortcut 3005, which, when selected by the sales associate, will launch calendar screen 3100, contacts screen 3300, messages screen 3400, sales associate profile screen 4000, and a search screen (not shown), respectively.

Sales associate home screen 3000 also includes home screen shortcut 3006. Normally, selecting home screen shortcut 3006 would launch sales associate home screen 3000. However, because sales associate home screen 3000 already is being displayed, home screen shortcut 3006 is disabled on this particular screen.

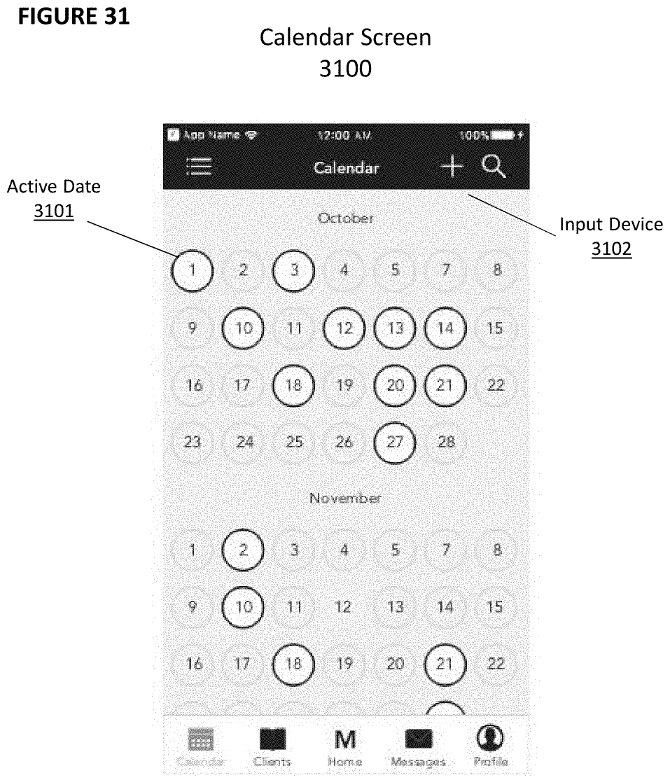

FIG. 31 depicts calendar screen 3100, which is displayed when a sales associate selects calendar shortcut 3001. Calendar screen 3100 depicts active date 3101, which here is a date containing a calendar entry (such as an appointment). Other active dates are shown and are indicated with white circles similar to active date 3101. Input device 3102 allows a sales associate to create a new calendar entry.

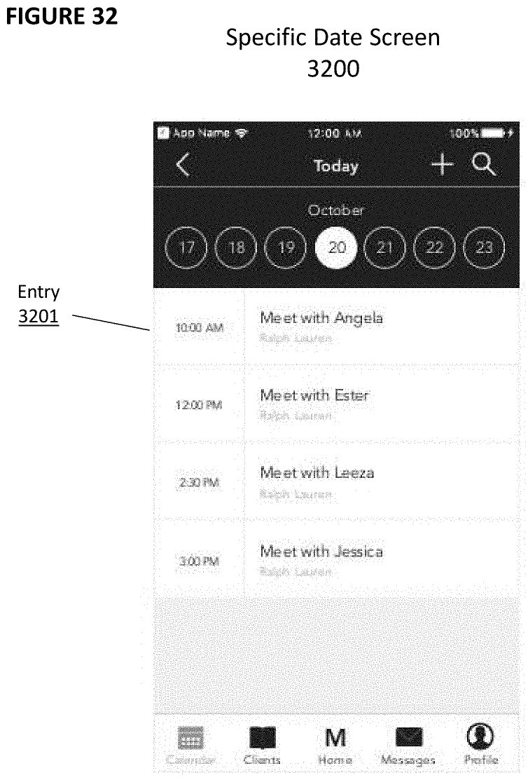

FIG. 32 depicts specific date screen 3200, which is displayed when the sales associate selects a specific date on calendar screen 3100. This particular date screen 3200 is for October 20. It displays entry 3201, which is an appointment at 10 am, described as “Meet with Angela.”

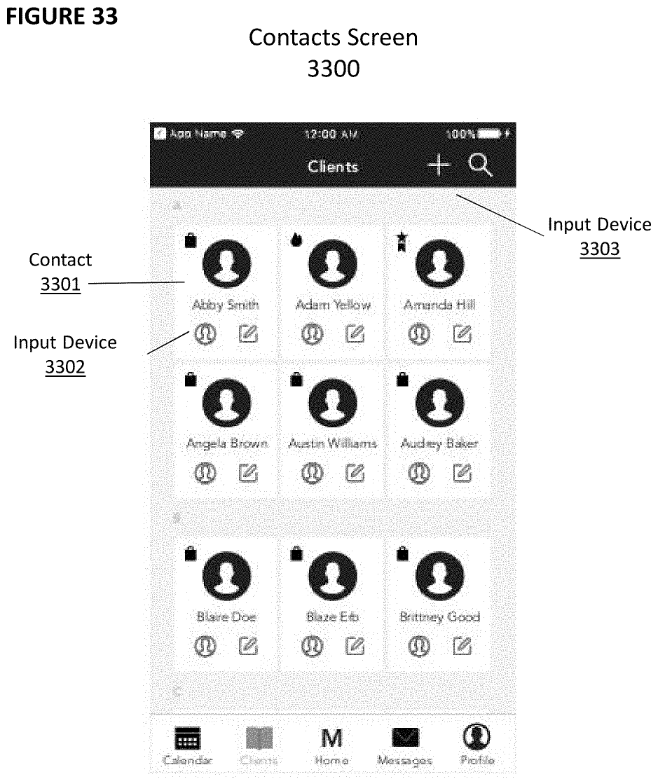

FIG. 33 depicts contacts screen 3300, which is displayed when a sales associate selects contacts shortcut 3002. This screen displays all contacts (customers, other sales associates, retail personnel, others) for the sales associate, such as exemplary contact 3301. Contact 3301 shows a name and photo for the client and input device 3302. Input device 3302, when selected, will display a profile screen for contact 3301. Input device 3303 allows the sales associate to add a new contact. Optionally, the sales associate can send a message to all of his or her contacts at one time. Optionally, the sales associate can limit the viewing of his or her posts to only his or her contacts.

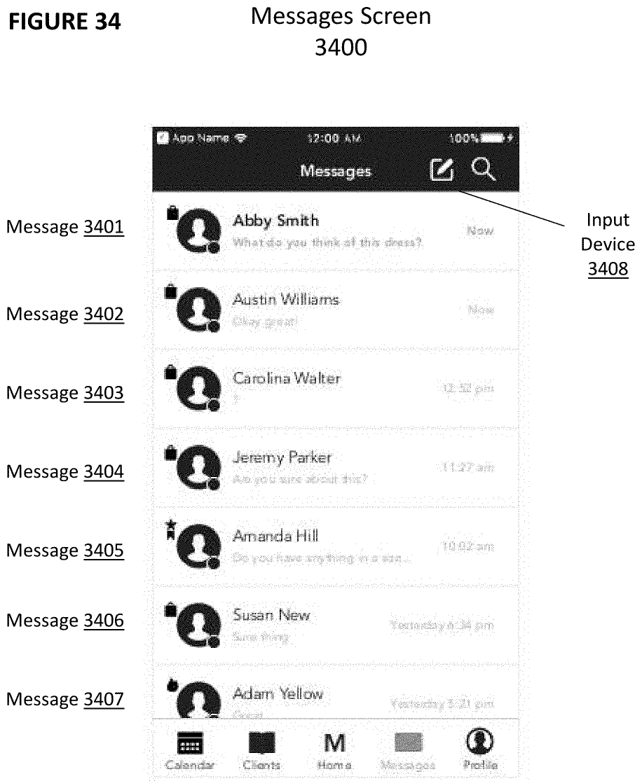

FIG. 34 depicts messages screen 3400, which is displayed in response to a sales associate selecting a message shortcut such as message shortcut 3003. Messages screen 3400 depicts messages 3401, 3402, 3403, 3404, 3405, 3406, and 3407 sent to the sales associate. Message screen 3400 also includes input device 3408, which, when selected by the sales associate, will allow the sales associate to draft a new message. This is a mechanism by which a sales associate can communicate with a customer.

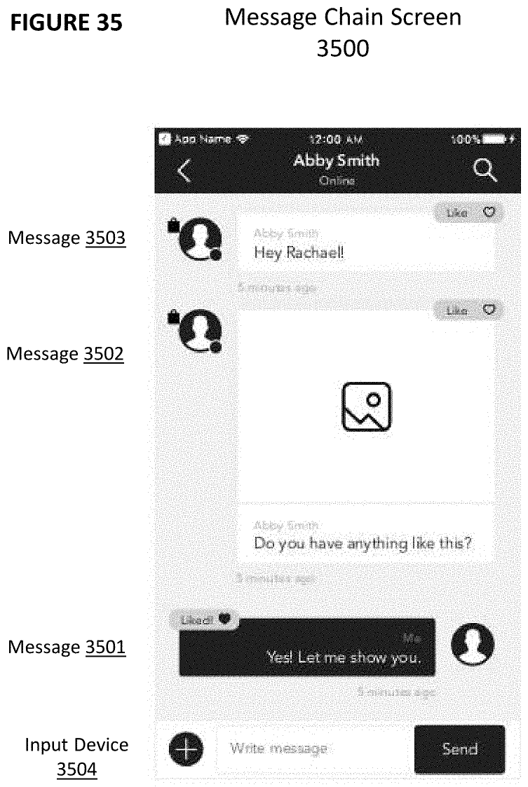

FIG. 35 depicts message chain screen 3500, which is displayed when the sales associate selects a particular message on messages screen 3400. This screen shows each message sent in a communication chain between the sales associate and Abby Smith (the exemplary customer operating computing device 100a), comprising messages 3501, 3502, and 3503. The sales associate optionally can send another message Abby Smith using input device 3504.

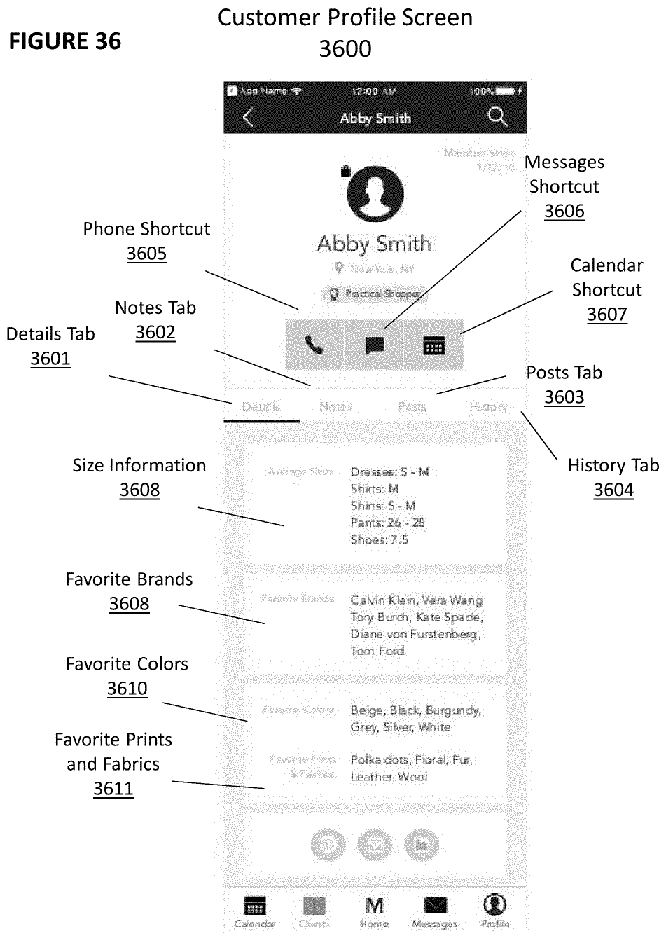

FIG. 36 depicts customer profile screen 3600, which is displayed when the sales associate selects a profile shortcut for the customer Abby Smith, such as input device 3302 in FIG. 33. This profile screen is similar to customer profile screen 2600 shown in FIG. 26, but this time is viewed by the sales associate on client device 100b. This screen includes details tab 3601, notes tab 3602, posts tab 3603, and history tab 3604. This screen includes phone shortcut 3605, messages shortcut 3606, and calendar 3607. On this particular screen, details tab 3601 has been selected or is active, and indicates this particular customer's size information 3608, favorite brands 3609, favorite colors 3610, and favorite prints and fabrics 3611. The profiles are managed by profile engine 601. Optionally, customer profiles can be made available only to contacts of the customer or to sales associates with whom the customer has made his or her customer profile available.

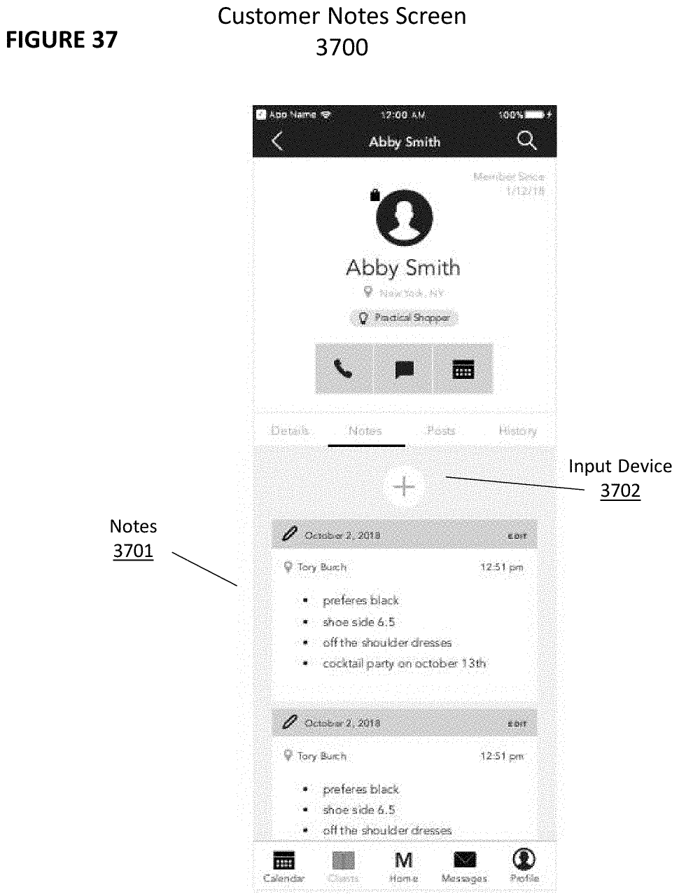

FIG. 37 depicts customer notes screen 3700, which contains the sales associate's notes about this particular customer and is displayed in response to the sales associate selecting notes tab 3602. Notes 3701 are displayed. Input device 3702, when selected by the sales associate, will allow the sales associate to create a new note about this particular customer. This will facilitate a long-term relationship between a sales associate and customer so that the sales associate will be able to customize recommendations to the customer in the future. This is one of the benefits of using sales associates at a brick-and-mortar stores that has not been available in the e-commerce systems of the prior art.

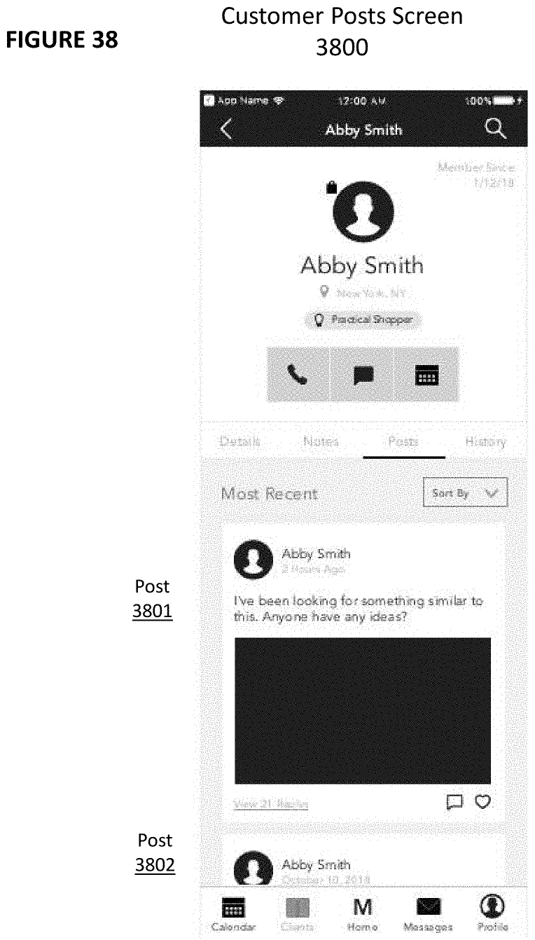

FIG. 38 depicts customer posts screen 3800, which displays posts by this particular customer, such as posts 3801 and 3802. The posts are managed by communication engine 604.

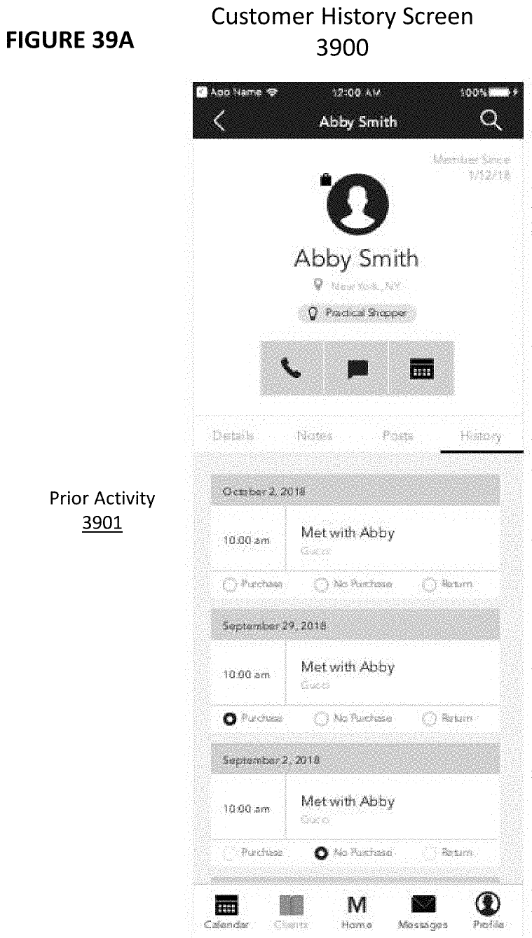

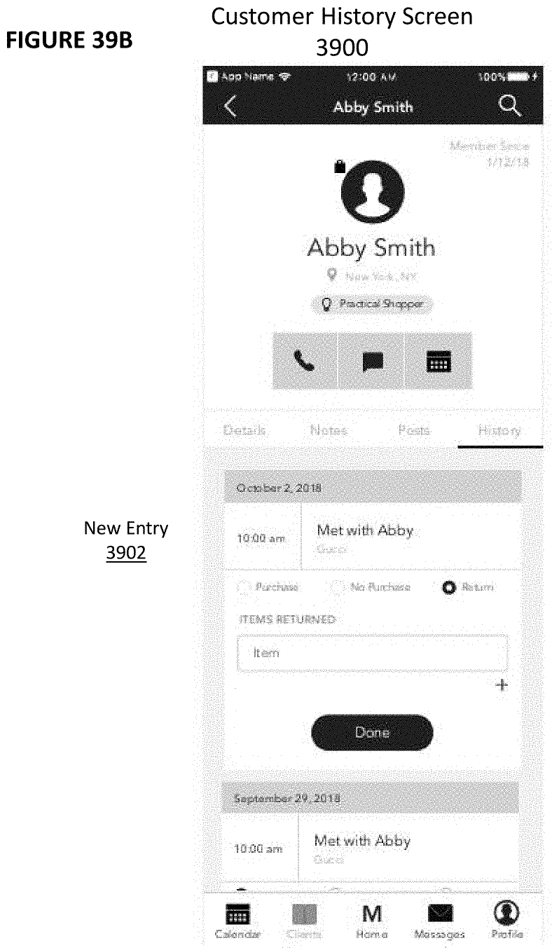

FIGS. 39A and 39B depicts customer history screen 3900, which displays prior activity 3901 by this particular customer. The sales associate also can create new entry 3902 to record new activity by the customer, such as a purchase, return, or no purchase. New entry 3902 can indicate the item that is the subject of the purchase or return. Once created, new entry 3902 becomes another prior activity that will be displayed in customer history screen 3900 thereafter.

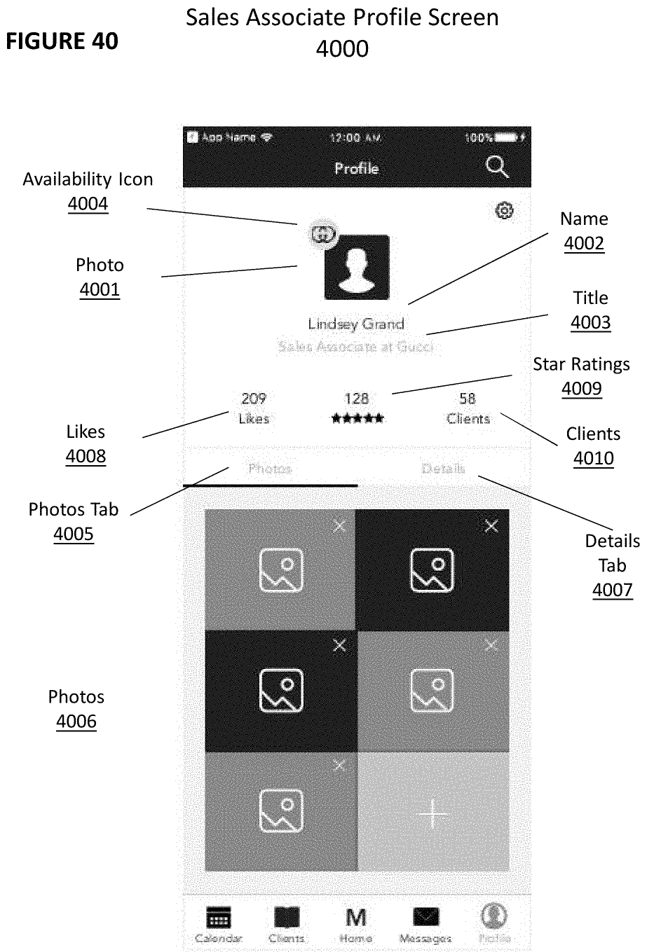

FIG. 40 depicts sales associate profile screen 4000, which is displayed when the sales associate selects profile shortcut 3004. This screen includes additional information about the sales associate, including photo 4001, name 4002, title 4003, availability icon 4004, photos tab 4005, photos 4006, details tab 4007, likes 4008, star ratings 4009, and clients 4010. The profile is managed by profile engine 601.

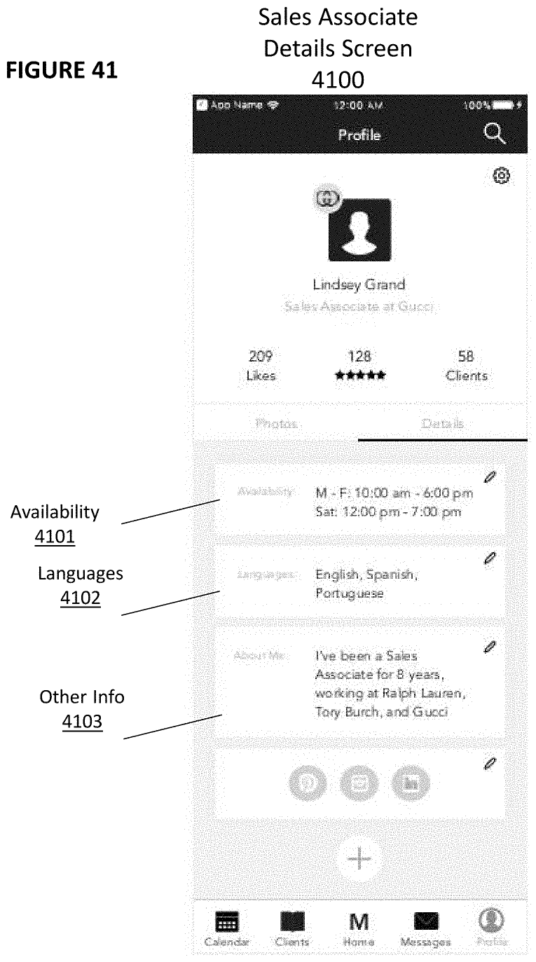

FIG. 41 depicts sales associate details screen 4100, which is displayed in response to the sales associate selecting details tab 4007, and includes availability 4101, languages 4102, and other info 4103.

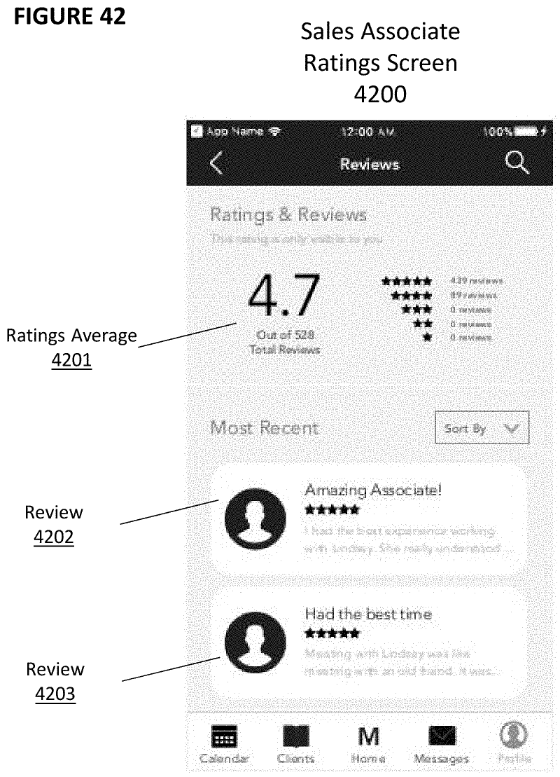

FIG. 42 depicts sales associate ratings screen, which is displayed in response to a customer or the sales associate selecting ratings 4009. This screen shows ratings average 4201, and reviews such as reviews 4202 and 4203.

Retail Transaction

Using the features described above, a customer can find a sales associate in his or her physical proximity, who is available to help, and who can find a retail item that might be interest to the customer. With reference again to FIG. 5, client device 100a might be operated by a customer, and client device 100b might be operated by a merchant. The customer operating client device 100a then can communicate with the merchant operating client device 100b, optionally with the assistance of server 300. Client devices 100a and 100b can exchange messages or posts and can enable phone communication between the customer and sales associate. For example, a sales associate and customer might exchange a series of messages in which the sales associate provides information and photos of merchandise, and the customer provides feedback.

If the sales associate identifies a retail item that the customer wishes to purchase, software application 600 can then provide a mechanism by which the customer can approve the purchase and a separate mechanism by which the customer and merchant execute the payment.

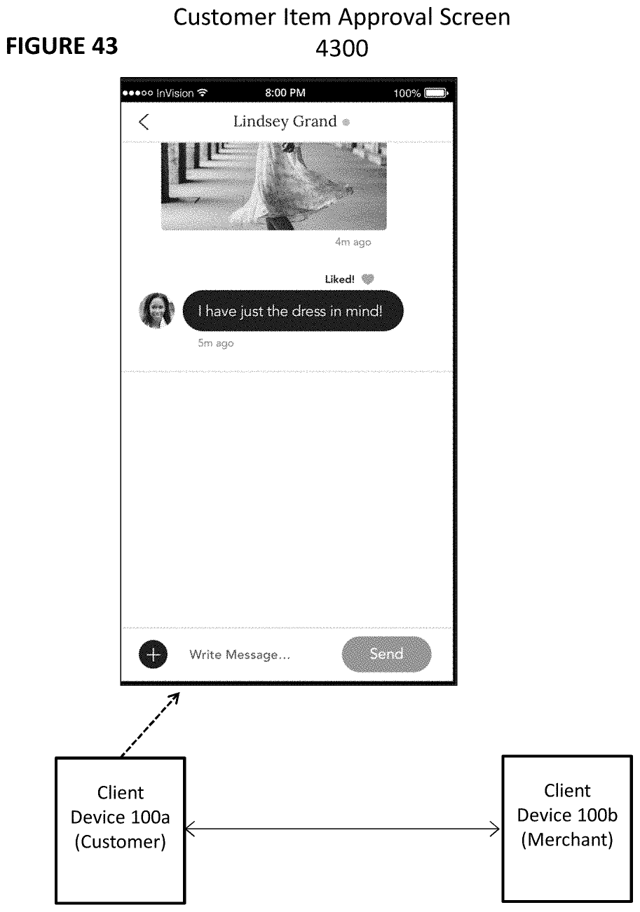

With reference to FIG. 43, if the customer desires to purchase an item, he or she can send a message or a “like” comment to the sales associate, as shown in customer item approval screen 4300. Other mechanisms for indicating that the customer wishes to purchase the item can be used, such as a message or a special input device that is selected when the customer wishes to purchase the displayed item.

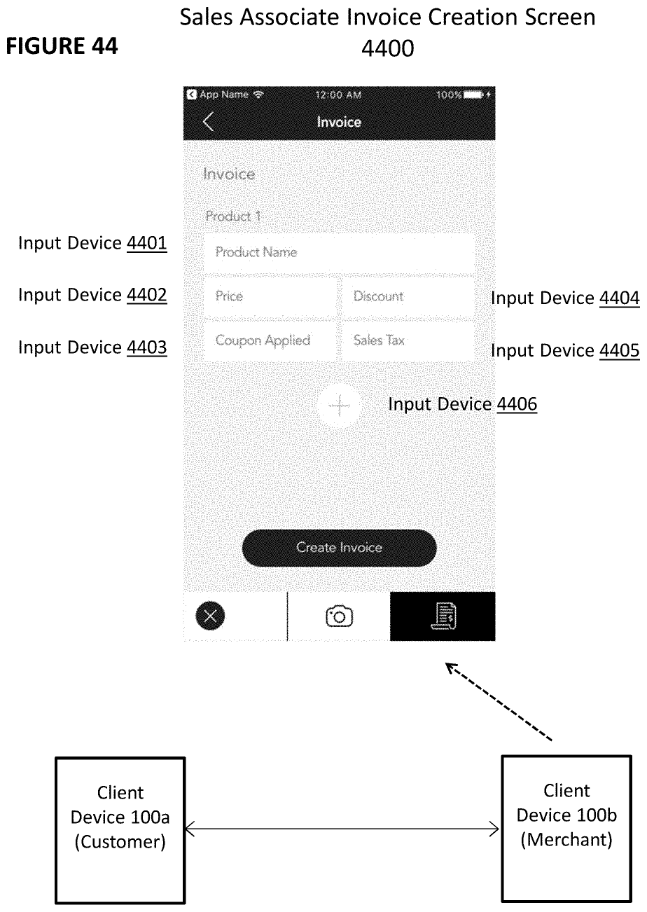

With reference to FIG. 44, the sales associate then will create an invoice, as shown in sales associate invoice creation screen 4400. Using input devices 4401, 4402, 4403, 4403, and 4405, the sales associate can enter the product name, price, discount, coupon applied, and sales tax, respectively. Optionally, those fields can be automatically populated by server 300 or retail server 502, for example, in response to the sales associate scanning a bar code on a physical item using image capture unit 106 in client device 100b. If an additional item needs to be added to the invoice, the sales associate can select input device 4406 to input another item.

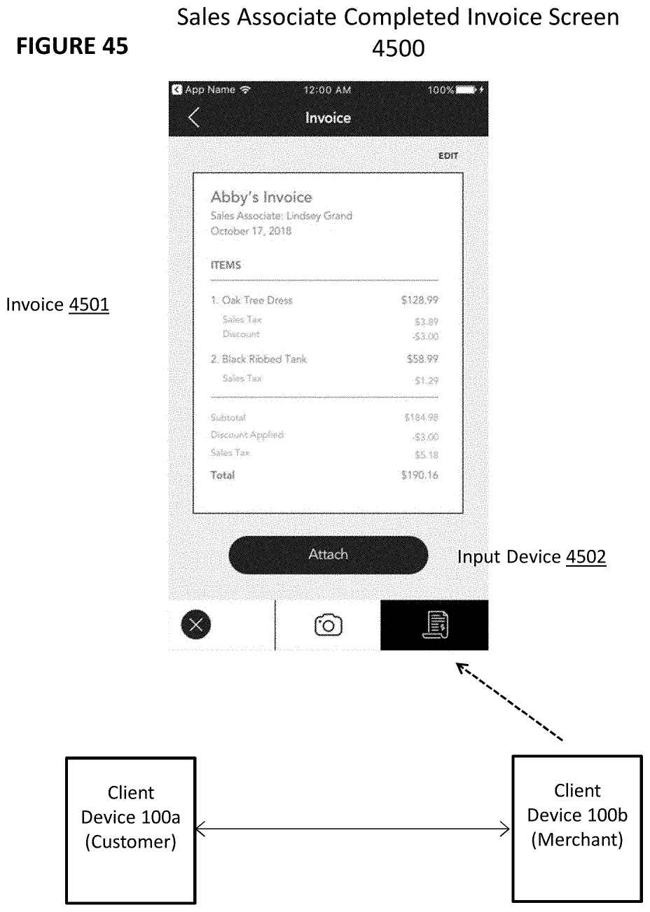

FIG. 45 depicts the completed invoice 4501 on sales associate completed invoice screen 4500. The sales associate then selects input device 4502 to attach the invoice to a message to the client device 100a.

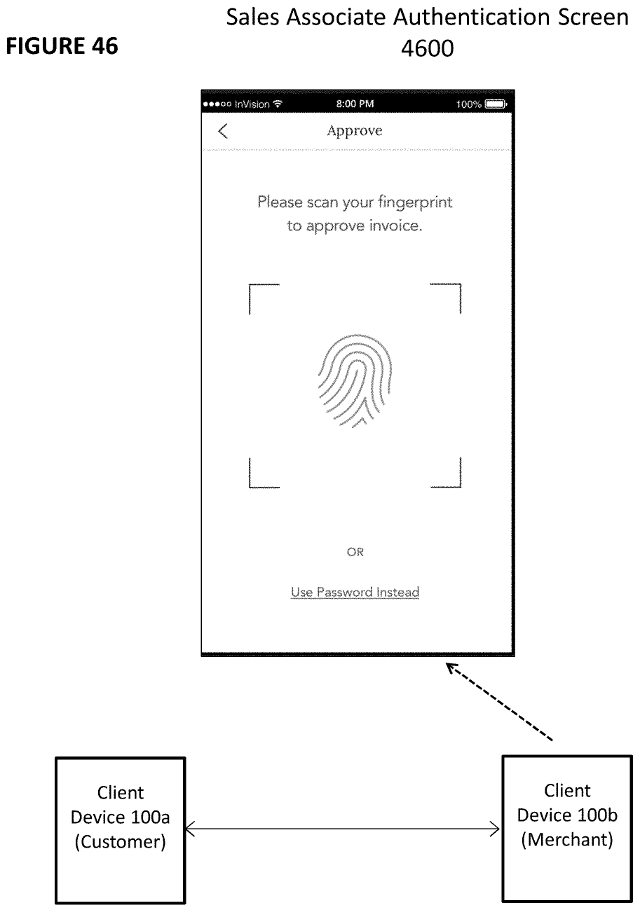

FIG. 46 depicts sales associate authentication screen 4600, which in this example prompts the sales associate to scan his or her fingerprint using fingerprint scanner 109 on client device 100b. In the alternative, it can request the sales associate to enter a password or some other authentication data. Server 300 then will compare the received data with the data previously stored in the sales associate's profile by profile engine 601. Once authenticated, server 300 enables invoice 4501 to be sent to client device 100a.

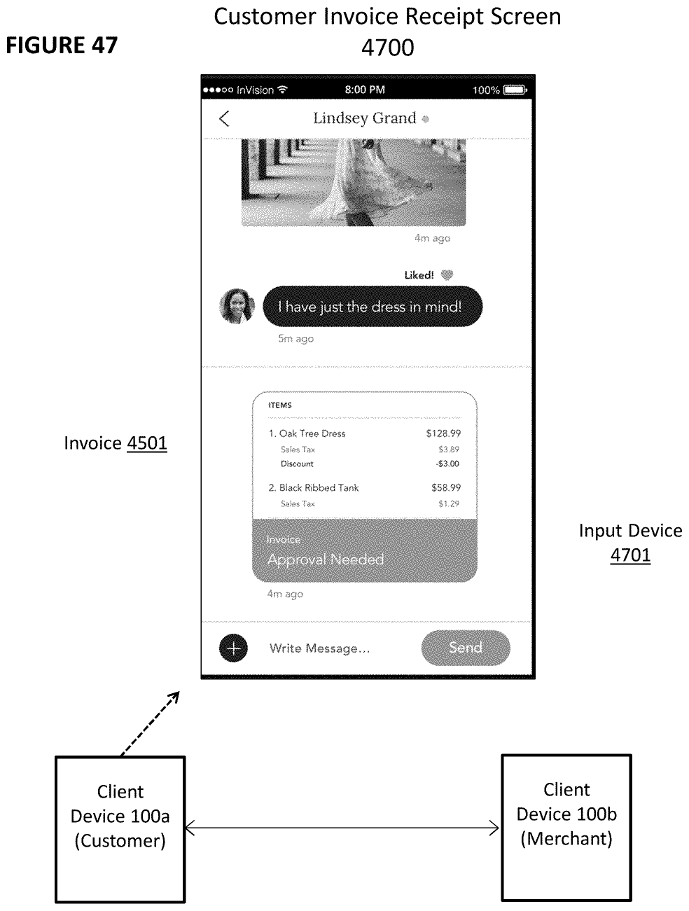

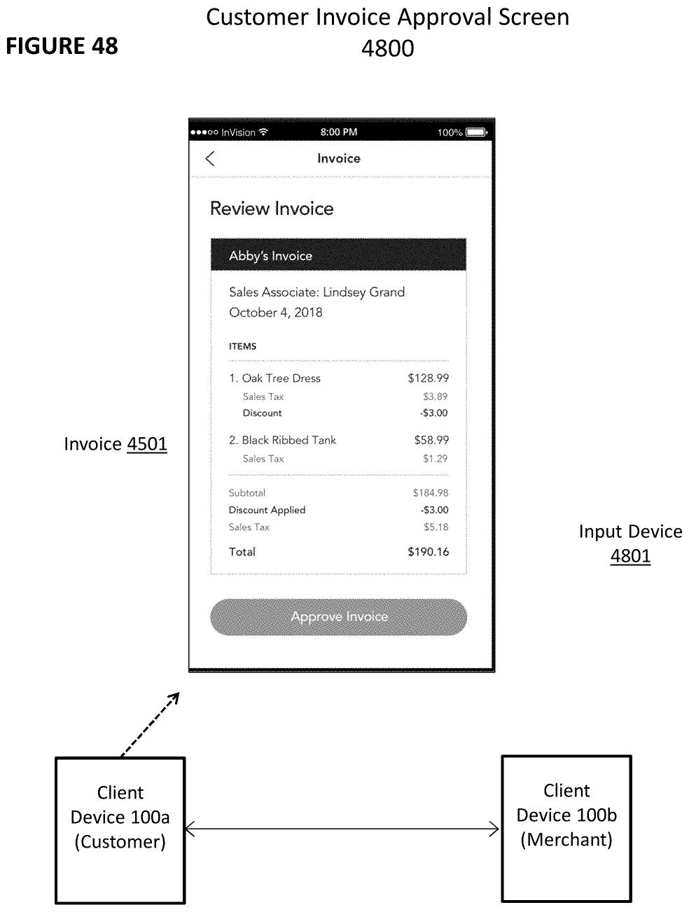

FIG. 47 depicts the received invoice on client device 100a as customer invoice receipt screen 4700, which shows invoice 4501. The customer selects input device 4701 to enter a mode in which the customer can approve the invoice. This is shown in FIG. 48 as customer invoice approval screen 4800, which shows invoice 4501. If the customer approves of the invoice, he or she selects input device 4801, here labeled as “Approve Invoice.”

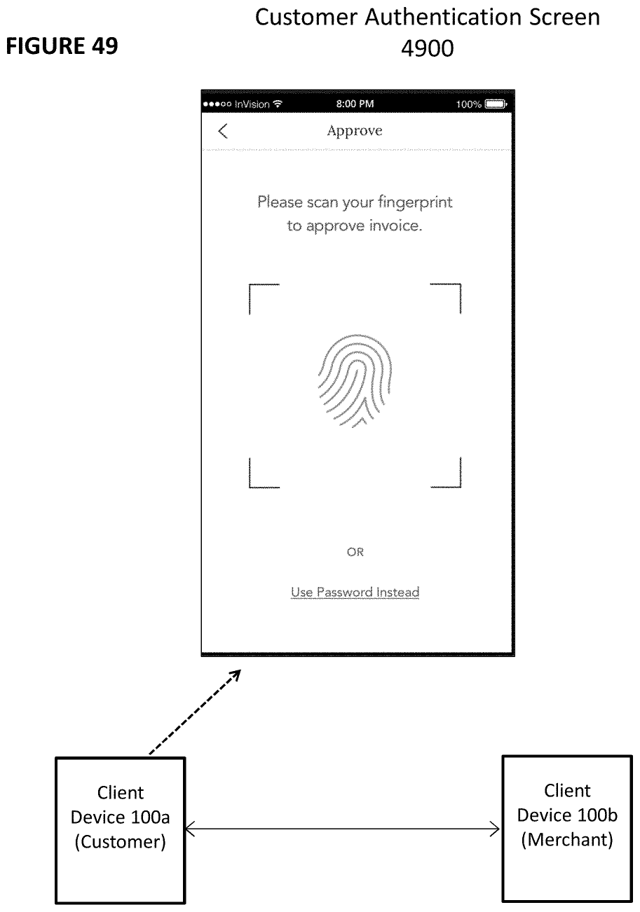

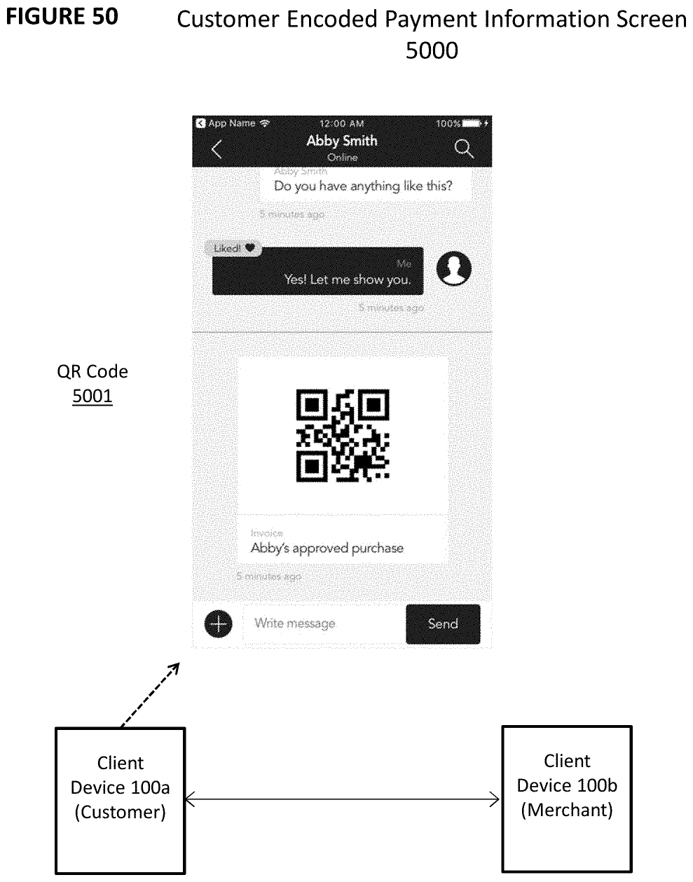

FIG. 49 depicts customer authentication screen 4900, which in this example prompts the customer to scan his or her fingerprint using fingerprint scanner 109 on client device 100a. In the alternative, it can request the customer to enter a password or some other authentication data. Server 300 then will compare the received data with the data previously stored in the customer's profile by profile engine 601. Once authenticated, server 300 instructs client device 100a to initiate the secure payment mechanism depicts in FIG. 50.

FIG. 50 depicts customer encoded payment information screen 5000. Payment engine 607 (which in this example resides within client application 202 within client device 100a) generates QR code 5001, which will encode one or more of the following types of data for the transaction:
Identity of Customer (e.g., login name);
Identity of Item (e.g., SKU number);
Quantity of Item Purchased;
Price of Item;
Sales Tax on Transaction;
Gratuity for Sales Associate;
Total Amount;
Credit Card Information (e.g., Credit Card Number, Expiration Date, Billing Address)'
Bank Information (e.g., Bank Routing Number, Bank Account Number);
Cryptocurrency Information (e.g., Identifier for the Cryptocurrency Known by the Trademark ETHEREUM);
Electronic Payment Information (e.g., User Name of the Online Payment Service Known by the Trademark PAYPAL);
Shipping Address;
Customer's Email Address; and
Customer's Phone Number.

Client device 100a then sends QR code 5001 to client device 100b.

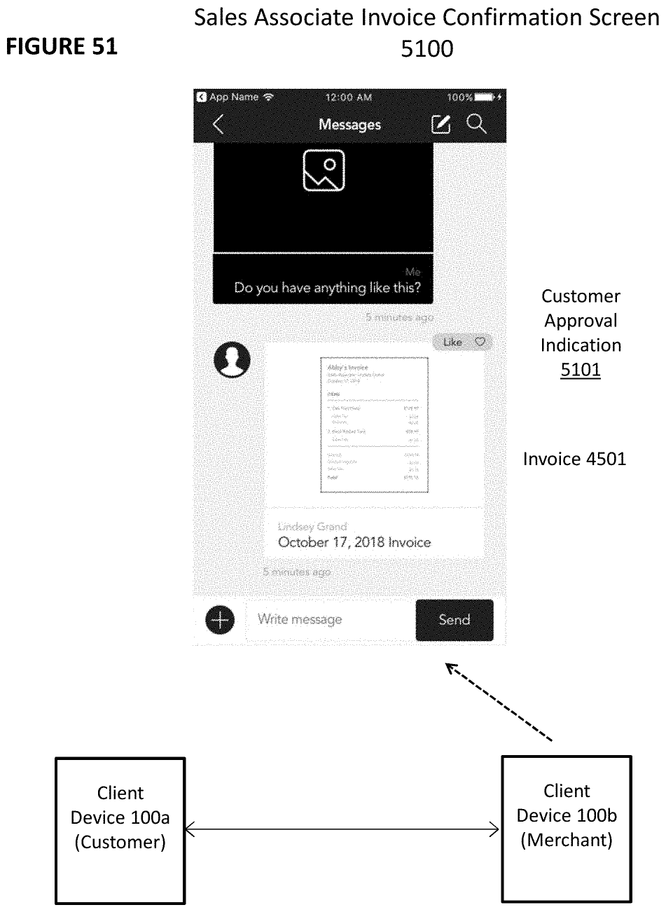

FIG. 51 depicts the receipt by client device 100b of confirmation that the invoice was approved by the customer, here shown on sales associate invoice conformation screen 5100. Invoice 4501 is shown, and the customer's approval is conveyed through customer approval indication 5101.

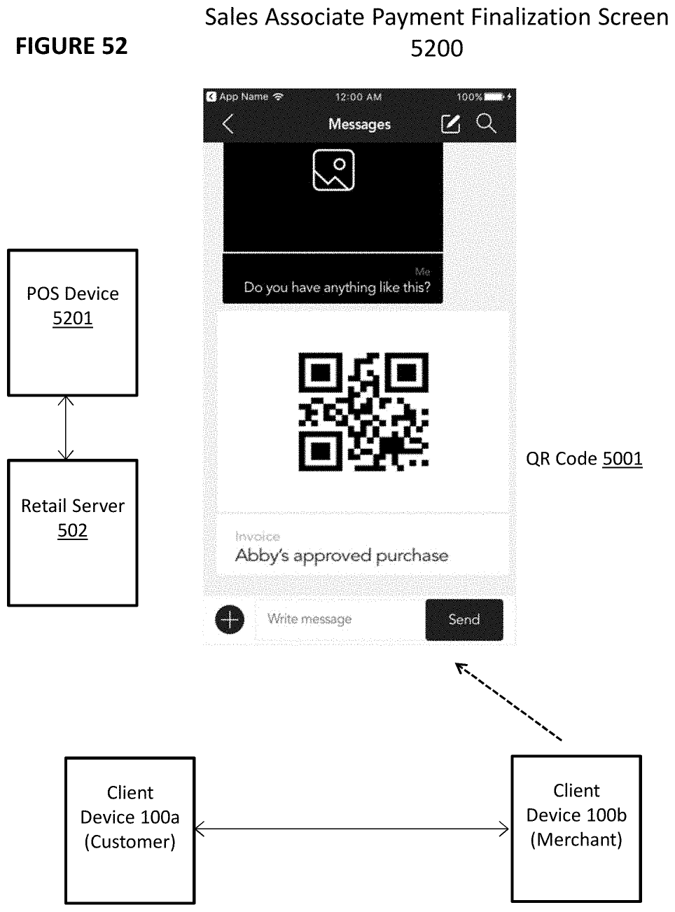

The sales associate is then prompted that he or she needs to complete the payment process. Client device 100b again prompts the sales associate for authentication information, as discussed previously in FIG. 46 sales associate authentication screen 4600. Once the sales associate is authenticated, client device 100b will display QR code 5001, as shown in FIG. 52 on sales associate payment finalization screen 5200. The sales associate will scan QR code 5001 into point of sale device 5201 (e.g., a cash register at a brick-and-mortar store). Point of sale device 5201 is coupled to retail server 502. Retail server 502 contains previously-installed interface engine 609 (depicted in FIG. 6), which is designed to communicate with server interface engine 606 operating within server application 402 and/or client devices 100. Interface engine 609 is able to decode QR code 5001, either in whole or in part. For example, interface engine 609 might be able to extract information to complete a credit card transaction but might not be able to extract information that is not essential to that process (such as the customer's shipping address). Retail server 502 then submits the charge to payment server 503, which then executes the payment using the credit card information, bank information, cryptocurrency information, electronic payment information, or other payment information extracted from QR code 5001.

Two other secure payment variations will now be described. Under a first variation, server 300 manages the payment. Server 300 receives QR code from client device 100a, decodes QR code 5001, extracts the encoded information, and submits the charge to payment server 503, which then executes the payment using the credit card information, bank information, cryptocurrency information, electronic payment information, or other payment information extracted from QR code 4801.

Under a second variation, server 300 decodes QR code 4801 and submits the relevant information to retail server 502. Retail server 502 then submits the charge to payment server 503, which then executes the payment using the credit card information, bank information, cryptocurrency information, electronic payment information, or other payment information extracted from QR code 4801.

Notably, under all three payment mechanisms, the private financial information of the customer (e.g., credit card information) is never provided to the sales associate in non-encoded, human-readable form. This provides a level of security that exceeds a typical purchase in a brick-and-mortar store, where a customer typically will utilize a physical credit card.

Once the payment is confirmed, client device 100b, retail server 502, or server 300 can facilitate the provision of the purchased item to the customer, either by causing it to be shipped to the customer at his or her shipping address or by sending a message to client device 100a requesting a time to meet so that the sales associate can provide the item to the customer.

The embodiments of the invention provide many of the benefits of brick and mortar retail along with many of the benefits of e-commerce. Customers are able to find sales associates in their physical proximity who possess expertise and interest in the types of merchandise of interest to the customer. The sales associate can provide options to the customer remotely using client devices. The customer need not visit a physical store, and the sales associate need not devote large amounts of time to the specific customer. Once the sales associate identifies an item that the customer wishes to purchase, the disclosed software application facilitates the transaction and provides a secure payment mechanism. Optionally, the sales associate needs to complete the transaction at a point-of-sale terminal in a brick-and-mortar store. This will avoid some of the “moonlighting” problems faced in the prior art by brick-and-mortar whose sales associates conduct business with customers wholly outside of the brick-and-mortar environment.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between). For example, forming an element “over a substrate” can include forming the element directly on the substrate with no intermediate materials/elements there between, as well as forming the element indirectly on the substrate with one or more intermediate materials/elements there between.

What is claimed is:

1. A method of identifying a sales associate and a retail item for a customer and executing a purchase of the item by the customer, comprising:
transmitting search parameters, by a first client device operated by a customer, to a server;
performing a search, by the server, based on the search parameters;
identifying a sales associate, by the server, based on the search;
generating, by the first client device, a message to a second client device operated by the sales associate;
providing, by the second client device, an image of an item and an identifier of the item;
generating, by the first client device, a QR code to purchase the item, wherein the QR code encodes information comprising an identifier of a customer, the identifier of the item, a transaction amount, and payment information for the customer;
transmitting the QR code to the server; and
decoding the QR code to obtain payment information for the customer.

2. The method of claim 1, wherein the payment information comprises a credit card number.

3. The method of claim 1, wherein the payment information comprises a bank account number.

4. The method of claim 1, wherein the payment information comprises cryptocurrency information.

5. The method of claim 1, wherein the payment information comprises electronic payment information.

6. The method of claim 1, further comprising:
prior to the step of transmitting search parameters, authenticating the customer using an authentication engine executed by the server.

7. The method of claim 6, further comprising:
prior to the providing step, authenticating the sales associate using the authentication engine.

8. The method of claim 1, wherein the step of identifying a sales associate comprises providing a profile for the sales associate to the first computing device.

9. The method of claim 1, wherein the step of identifying a sales associate comprises generating a map on the first client device that indicates a location of the first client device and a location of the second client device.

10. The method of claim 1, wherein the step of identifying a sales associate comprises indicating availability of the sales associate.

11. A server for facilitating electronic commerce comprising a processing unit, a non-volatile storage device, and a network interface, wherein the non-volatile storage device stores instructions executable by the processing unit for:
performing a search based on search parameters received over the network interface from a first client device;
identifying a sales associate based on the search;
transmitting an image of an item and an identifier of the item to the first client device in response to a communication received over the network interface from a second client device;
receiving a QR code from the first client device; and
decoding the QR code to obtain payment information.

12. The server of claim 11, wherein the payment information comprises a credit card number.

13. The server of claim 11, wherein the payment information comprises a bank account number.

14. The server of claim 11, wherein the payment information comprises cryptocurrency information.

15. The server of claim 11, wherein the payment information comprises electronic payment information.

16. The server of claim 11, wherein the step of identifying a sales associate comprises providing a profile for the sales associate to the first computing device.

17. The server of claim 11, wherein the step of identifying a sales associate comprises generating a map on the first client device that indicates a location of the first client device and a location of the second client device.

18. The server of claim 11, wherein the step of identifying a sales associate comprises indicating availability of the sales associate.

19. A method of performing electronic commerce, comprising:
displaying, on a first computing device, a profile for a sales associate;
transmitting a message, by the first computing device, to a second computing device;
operated by the sales associate;
transmitting information for merchandise from the second computing device to the first computing device;
generating, by the first client device, encoded data that comprises an identifier of a customer, an identifier of the merchandise, a transaction amount, and credit card information for the customer;
transmitting, by the first client device, the encoded data to a first server;
decoding, by the first server, the encoded data; and
transmitting, by the first server, a request to a second server to bill the credit card for the transaction amount.

20. The method of claim 19, further comprising:
transmitting, by the first server, a message to the second client device confirming the transaction.
